(19) United States
(12) Patent Application Publication
(10) Pub. No.: US 2009/0249076 A1
(43) Pub. Date: Oct. 1, 2009

(54) INFORMATION SERVER AND MOBILE DELIVERY SYSTEM AND METHOD

(75) Inventors: William C. Reed, Moosic, PA (US); William Drew Palin, Mequon, WI (US); Dennis Wozniak, Dunmore, PA (US); Thomas A. Druby, Mountain Top, PA (US); Daniel Thomas Hynes, Dallas, PA (US); Patrick Jason Kinney, Clarks Summit, PA (US); Warwick Antony Charlton, Raleigh, NC (US); John Greg Pollak, Mountain Top, PA (US); Erik Lazlo Manassy, Hawley, PA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: AllOne Health Group, Inc., Wilkes-Barre, PA (US)

(21) Appl. No.: 12/416,655

(22) Filed: Apr. 1, 2009

Related U.S. Application Data
(60) Provisional application No. 61/041,392, filed on Apr. 1, 2008.

(51) Int. Cl. G06F 17/30; G06Q 50/00; G06F 17/20; H04L 9/32; G06F 15/16

(52) U.S. Cl. 713/181; 705/3; 707/3; 715/222; 707/E17.108; 707/104.1; 707/E17.044; 709/203; 715/234; 713/168; 709/217; 709/227; 707/9; 726/5

(57) ABSTRACT

A user is provided with access to his or her account information using a client. The account information is stored on a server which receives the information from a feed source and transmits the information to the client. A method for downloading and installing specialized software for viewing the account information on the client is also provided. The information can be received from different feed sources in different formats and converted to a format that is compatible with the intended receiving client. Encryption can be used to protect the privacy of the users of the system and the account information therein. Additionally, a special access password and a privileged access routine can be used to provide access to an authorized third party user on a temporary basis.

### CROSS-REFERENCE TO RELATED APPLICATIONS

This application claims the benefit of U.S. Provisional Application No. 61/041,392, filed Apr. 1, 2008, and entitled “Information Server and Mobile Delivery System and Method,” which is herein incorporated by reference in its entirety.

### BACKGROUND OF THE INVENTION

1. Field of the Invention

The present invention relates to systems and methods for distributing, storing, and receiving user account information. More specifically, embodiments of the present invention can receive medical account information such as personal health records from a feed source, store the information in memory, and transmit the information to mobile clients.

2. Background of the Invention

Individuals, businesses, organizations, and other legal entities (“users”) have a variety of facilities to enable them to obtain, view, and maintain information. With the advent of computers, relational database management systems (RDBMSs) and the Internet, information that was once stored in physical files in paper form is now readily available and being brought into the crosshairs of ubiquitous search engines. Information that has been scanned, converted into machine-readable text by using Optical character recognition (OCR) technology, and indexed, is often readily available to the public online. Many types of information are best left protected from public access and beyond the view of search engines. One such type of information, account information, may include information pertaining to bank accounts, retirement accounts, credit card accounts, mobile phone accounts, utility accounts, insurance accounts, tax accounts, email accounts, merchant accounts, etc. Users seldom deliberately place this type of information online because of the omnipresent threat of identity theft and subsequent use of the information to the user's and society's detriment. In the past, users would store account information on paper in filing cabinets or on their person. For some types of account information, society found it useful to store account information on smart cards and encoded in magnetic strips of plastic cards such as medical insurance cards, credit cards, debit cards, merchant cards, gift cards, etc. To help offset the risks involved in placing this information online, various forms of Internet security have been employed.

Today, one can view electronic account information by logging into a company's web page and furnishing account information or logon credentials. By typing in some account information such as an account number, user name, password, sitekey, secret question, zip code, date of birth, maiden name, etc, an electronic account can be created. This account can be used to download encrypted information from the company, which will then be decrypted and displayed by the user's web browser. This process has greatly reduced the need for companies to mail information, and has made account information readily accessible from any computer with an Internet connection.

Despite the ability to view one's information from any computer having an Internet connection, users of mobile devices often find they need account information when a wireless Internet connection is unavailable. Whether at a school, library, airport, or a coffee shop, a user who depends on another to provide an Internet connection (i.e., via a WiFi connection), has to deal with use charges, inconvenient hours, range limitations, web filtering, bandwidth caps, and privacy concerns. To help offset this technology's limitations, technologies such as wireless third generation (3G) networks have been developed. This technology allows for high speed downloads and uploads, but has its own limitations including spotty satellite coverage, range limitations from the satellite broadcasting the signal, and expensive fees for using the service. Additionally the chip that powers this technology occupies a large footprint and quickly consumes battery power. As a result, a large number of devices utilize slower wireless technologies such as the Edge® network. Slower wireless technologies may be useful for slowly surfing the web, but are not particularly useful for uploading or downloading large amounts of data.

Mobile devices are in common usage, many featuring powerful processors, larger and more colorful displays, and wireless networking capabilities. Despite these advances in mobile technology, as compared to desktop and laptop computers, mobile devices typically have greater limitations on memory capacity, data storage capacity, central processing unit (CPU) capabilities, and networkability. Given the versatility of mobile devices, it is desirable to implement means by which these mobile devices can interact with servers to synchronize and display account data in the context of potentially intermittent, unreliable, occasionally-connected, or temporarily-unavailable networking capabilities.

Advancement in mobile devices such as mobile phones, personal digital assistants (PDAs), smart phones, hand held computers, palmtop computers, ultra-mobile personal computers (PCs), devices operating according to the Microsoft Pocket PC specification with the Microsoft Windows® CE operating system (OS), devices running the Symbian OS, devices running the Palm OS®, and devices capable of running mobile browsers such as Internet Explorer® (IE) Mobile have made it possible to connect to the Internet without a laptop. However, the limited screen size and computing power of these devices also limits the capabilities of the Internet browsers installed on these devices. As a result, these devices are often unable to display complicated web content and unable to comply with the rigorous Internet security measures employed by account websites.

When using the present invention, a user can view his or her account information live if he or she has a connection to the Internet. If no Internet connection is available, the user can view his or her information offline. Viewing an offline web page is supported by Internet browsers such as Internet Explorer® (IE), IE Mobile, Firefox®, and Safari. Internet browsers for mobile and non-mobile platforms can save and synchronize Internet web pages. Internet browsers such as IE, Firefox®, and Safari can save the information they download so that a web page can be viewed later without an active Internet connection. However, web browsers are not programmed to selectively store certain information nor do they have the ability to protect sensitive information that would be necessarily stored in saving the contents of the web page. As a result, most web browsers simply store copies of viewed web pages for a certain amount of time. To avoid congesting a computer with cached data, web browsers often set a limit on how much data will be saved. Using a web browser's cache may provide offline content in certain circumstances, but not in others. When a web page to be saved features dynamic or scripted information, an Internet browser will only save the last viewed screen. For example, a Uniform Resource Locator (URL) address for the website for accessing a web-based email client such as Google's Gmail® is typically static. However, the information displayed on the web page changes dynamically as email is added and deleted from the inbox of the email account. As a result, relying on an Internet's browser cache to view an email sent two weeks ago is ineffective.

An additional shortcoming of the browser-cache model for viewing information is that web controls cannot be used to vary the display or content of the page. For example, if a user of a bank website wants to view all the checks that have been deposited in a given time period such as the past month or year, the user could use the bank's website to download this information, provided the user has an active Internet connection. Without an active Internet connection, the user could view any cached pages on his computer, but these pages will not provide this particular set of information in cases where the account information (i.e., deposited checks) has changed since the pages were cached. Additionally, most current web browsers do not store, in cache, pages that have been encrypted. This step is taken to prevent other users and programs from browsing through a user's web cache for sensitive or private information.

Accordingly, what is desired is a means of securely providing account information to users of mobile devices. What is further is desired are methods, systems, and devices for accessing and viewing account information on mobile devices.

### SUMMARY OF THE INVENTION

The present invention includes methods, devices, and systems for providing account information to a user. In embodiments of the invention, the account information may be viewed online or offline. The methods, devices and systems may provide the user with access to his or her account information by collecting the information at a server that can receive information from a feed source and transmitting information to a client. Additionally, methods for downloading and installing (i.e., provisioning) specialized software for viewing the account information on the client are disclosed. Also, specialized software for converting the information received from the feed sources to a different format is disclosed. According to embodiments of the invention, software may determine the syntax of the format that is compatible with the intended receiving client. The software may also contain routines that allow the server to determine if it has any account information associated with a particular user or client. The software may comprise a host of different encryption systems to protect the privacy of the users of the system and the account information therein. Additionally, the software may comprise a special access password feature, which allows a second user to view or modify the first user's account information. Also, the software may contain a privileged access routine that allows the first user to enable an option in the second user's account to view or modify the first user's account information.

For example, in accordance with an embodiment of the present invention, an electronic information system provides account information to a user. The system may comprise a server having a database and a client. The server may comprise software having: a reception routine comprising instructions to cause the server to receive feed source information from a feed source; a storage routine comprising instructions to cause the server to store the feed source information as account information in the server; a selection routine comprising instructions for causing the server to select a subset of the account information stored by the storage routine; and an output routine comprising instructions for causing the server to send the subset of the account information to the client. The client may comprise software having: a reception routine comprising instructions for causing the client to receive the account information from the server; a storage routine comprising instructions to cause the client to store the information in the client; and a display routine comprising instructions for causing the client to display the account information received during the client's reception routine.

An embodiment of the invention provides an information server comprising software for processing and distributing account information and a database. The software may comprise a reception routine comprising instructions to cause the server to receive feed source information from a feed source. The software may also have a processing routine comprising instructions that, if executed, cause the server to convert the feed source information received from a first format into a second format; and a storage routine comprising instructions to cause the server to store the feed source information as account information in the second format in the server. Additionally, the software may also have: a selection routine comprising instructions for causing the server to select a subset of the account information stored by the storage routine; a transmission routine comprising instructions to cause the server to send the subset of account information to a web server; and an output routine comprising instructions for causing the server to send the sub-potion of the account information to the client.

In accordance with an embodiment of the present invention, a method for using a client having a database to download account information from a server is disclosed. The method may comprise the following steps: using a computer to provide a server with identification information; transmitting an encryption key to the computer; transmitting a uniform resource locator (URL) to the client; downloading software located at the URL using the client; installing the software on the client; entering the encryption key into the software; and updating the database of the client.

An embodiment of the invention includes an information server for receiving account information from at least a first and second feed source, changing the format of the received information into a second format, and outputting the information to at least one client. The information server may comprise a processor and memory for executing software to cause the server to perform a number of steps. The steps may include: receiving feed source information from the first feed source in a first format; converting the feed source information from the first feed source from the first format to a second format; receiving feed source information from the second feed source in a third format; converting the feed source information from the second feed source from the third format to the second format; storing at least some of the converted feed source information as account information; and distributing at least a portion of the account information to the client.

According to an embodiment, the information server receives account information from a feed source and distributes the information to a client. The information server may comprise a memory and software to cause the server to execute a number of routines. These routines may include a reception routine for receiving feed source information and a first set of identification information from the feed source; a storage routine for saving: the feed source information as account information in the memory of the server, and the first set of identification information in the memory of the server; a request routine for requesting a second set of identification information from the client; and a registration routine for registering the second set of identification information of the client with at least a portion of the account information in the server by comparing the first set of identification information with the second set of identification information.

An embodiment of the invention includes a system capable of allowing a first user to view his or her account information on a mobile device. The mobile device may comprise software for causing the mobile device to execute a number of routines. These routines may include an installation routine that requires the first user to enter an encryption key to allow the software to decrypt the account information; and a password to prevent users who do not know the password from accessing the account information; a display routine that allows the first user to view various types of account information saved in an encrypted format in the memory of the mobile device; a decryption routine that allows the viewing routine to use the encryption key to decrypt the information; a reception routine that causes the mobile device to connect to an information server to request new account information; and a storage routine that causes the mobile device to store information received from the information server.

An additional embodiment of the invention includes a computer or server comprising a set of information written in a first format, and a processing routine. The routine may cause the computer or server to determine the identity of the set of information written in the first format. The identity of the set of information written in the first format may be selected from the group consisting of: source code that can be compiled, a script that can be executed, a markup language having markup tags, and plain text. The computer or server may also: interpret the information if the information is a markup language; store any information generated by interpreting the markup language; transform the stored information from the first format into a second format; determine the identity of the information in the second format; and output the information to a display or a printer.

An embodiment of the invention includes a system that enables the secure exchange of medical information between users, health care providers, and health plans through mobile technology. In an embodiment, the medical information may comprise a Personal Health Record (PHR). The system allows user to wirelessly download mobile application software to a mobile device such as a wireless phone or a personal digital assistant (PDA). After downloading the mobile device software, users can then use the application to access their existing PHR data, which is stored securely on one or more remote servers.

The system allows individual users to store confidential personal information, including, for example, health care provider, insurance data, allergy information, immunization records, hospitalization records, and medication/prescription data. The mobile device software allows a user to synchronize his/her mobile device with his/her online PHR. Additionally, the system allows individual users to fax PHR information to any fax number from their mobile device.

The system also allows users to share access to selected subsets of their PHR information with other users when they authorize by granting one-time viewing privileges to guest users, such as a caregiver or physician. This temporary access is given through use of a newly generated username/password combination that remains active for a predetermined number of logins and/or a duration of time. According to an embodiment of the invention, the temporary access remains active for a predetermined number of logins or a duration of time, whichever comes first. In one embodiment, the time limit is preset to 24 hours and cannot be changed. In another embodiment, the temporary access remains active for one guest user logon or 24 hours limit, whichever comes first.

The system also includes mobile device software that allows an emergency responder to access a designated subset of the user's health care data such as known allergies, any existing medical conditions, medical history, blood type, and any current prescriptions.

In an embodiment, the mobile device software can also be used to exchange questions and responses with a server through a messaging system. These question/response exchanges can comprise a ‘decision tree’ whereby a series of questions are sent to a mobile device with subsequent questions being based on the range of potential answers to previously sent questions. The decision tree maps out the range of possible answers to one or more subsequent questions based on responses to prior questions in the decision tree. In this way, the mobile device software enables users to receive relevant and timely communications on health care-related topics at their mobile devices.

The system integrates with existing health care information systems and applications, including existing third party, online PHR providers. The mobile device software comprises a compiled application that is downloaded to, stored on, and run from a user's mobile device.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

FIG. 1 depicts an electronic information system, in accordance with an embodiment of the present invention.

FIG. 2 illustrates three exemplary embodiments of the various types of clients useful in the present invention.

FIG. 3 depicts the types of tags that may be included in the information sent from a feed source, in accordance with an embodiment of the present invention.

FIG. 4 illustrates how information may flow through the various components in the system, in accordance with an embodiment of the present invention.

FIG. 5 illustrates how information may be exchanged between a mobile device and servers, in accordance with an embodiment of the present invention.

FIG. 6 depicts how feed source information may be formatted using a server's processing routine, in accordance with an embodiment of the present invention.

FIG. 7 shows an exemplary embodiment of how information is exchanged with a client.

FIG. 8 illustrates an embodiment of the invention utilizing a special access password.

FIG. 9 illustrates an embodiment of the invention utilizing a privileged access routine.

FIG. 10 illustrates how information is exchanged between a terminal, a server, and a web server, in accordance with an embodiment of the present invention.

FIG. 11 depicts how information is sent to a PC, in accordance with an embodiment of the present invention.

FIG. 12 illustrates a modular view of a system for provisioning software from a server to a mobile device, in accordance with an embodiment of the present invention.

FIG. 13 is a flowchart illustrating steps by which software is provisioned from a server to a mobile device, in accordance with an embodiment of the present invention.

FIG. 14 provides a Message Sequence Chart (MSC) of a method for enabling an emergency responder to see emergency information on a mobile device, in accordance with an embodiment of the present invention.

FIG. 15 provides an MSC of a method for exchanging question/response messaging between a mobile device and a server, in accordance with an embodiment of the present invention.

FIG. 16 provides an MSC of a method for exchanging questions and a decision tree of related answers between a mobile device and a server, in accordance with an embodiment of the present invention.

FIGS. 17A-I depict a graphical user interface (GUI) for an electronic information system that displays claims information, guest accounts, other accounts, and messaging settings, according to an embodiment of the invention.

FIGS. 18A-G depict a GUI for an electronic information system that displays summary account data, according to an embodiment of the invention.

FIGS. 19A-J depict exemplary graphical user interfaces (GUIs) for viewing summary account data on mobile device 300, in accordance with an embodiment of the present invention.

FIGS. 20A and 20B depict a GUI for viewing messages on a mobile device within an exemplary GUI, in accordance with an embodiment of the present invention.

FIGS. 21A and 21B depict a GUI for viewing guest user settings on a mobile device, in accordance with an embodiment of the present invention.

FIG. 22 depicts a GUI for displaying summary data on a mobile device, according to an embodiment of the present invention.

FIG. 23 depicts an example computer system in which the present invention may be implemented.

### DETAILED DESCRIPTION

The present invention relates to systems and methods that allow a user to obtain information. Broadly speaking, the present invention could be used to provide any user any particular type of information, though certain types of information may be more useful with the present invention. While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The detailed description of embodiments of the present invention is divided into several sections. The first section provides definitions of terms used to describe embodiments of the invention.

### DEFINITIONS

As used herein, a personal health record (PHR) is any collection of medical data that is maintained by an individual or an organization on behalf of an individual or a selected subset of that data. A PHR may be a collection of medical history data pertaining to an individual user that is collected and maintained by health care providers, insurers, and government organizations. A PHR may provide a complete and accurate summary of the health and medical history of an individual by gathering data from many sources, including, but not limited to hospitals, physicians, pharmacies, assisted living facilities, medical clinics, and health insurance companies. An individual PHR can contain a diverse range of data, including insurance account information. A PHR may include information about one or more of: an individual's allergies and adverse drug reactions; medications prescribed to the individual—including past and current prescriptions, dosage, frequency, related prescriptions, interactions with other drugs and foods, side effects, doses, dosage schedule, and remaining refills; over the counter medication history—including past and present medications and herbal remedies obtained from pharmacies, clinics, and online providers; the individual's illnesses and hospitalization history; surgeries and other procedures performed on the individual; the individual's vaccination history; laboratory test results for the individual—including but not limited to blood analysis, urinalysis, drug tests, biopsies; any clinical trials the individual has participated in; psychological evaluations; and the individual's family medical history. Information stored in a PHR may be used to check for potential/future prescriptions and procedures (i.e., drug-drug interaction checking or electronic messaging between patients and providers regarding potential issues related to a scheduled procedure). Information stored in a PHR may be used to send messages tailored to an individual. These messages may include, but are not limited to information related to the individual's current or past illnesses, reminders for health care appointments, reminders to refill prescriptions, and reminders to take medication. PHR data may be hosted by a third party and accessible via a client. A PHR may be maintained by an individual via a client connected to a server where the PHR is securely stored.

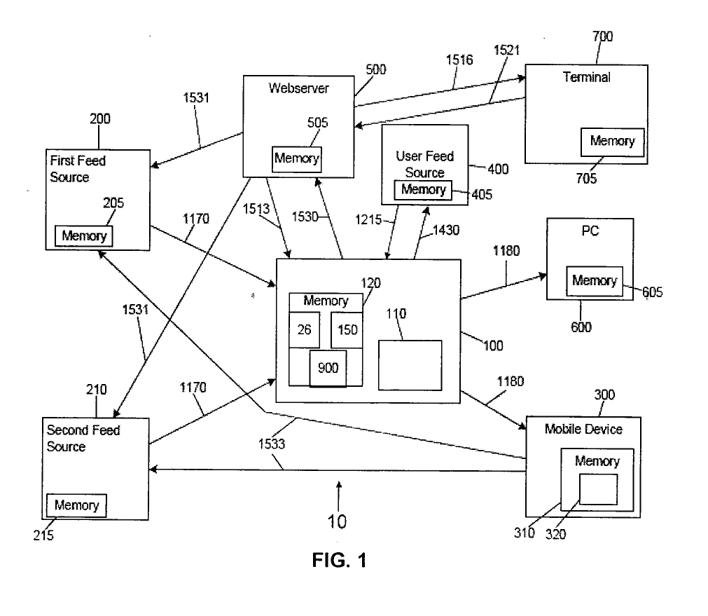

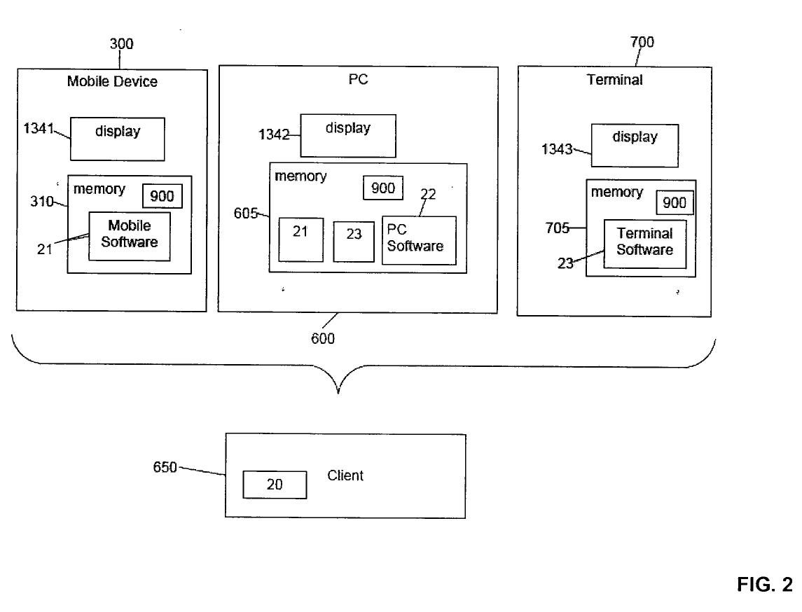

Referring to FIGS. 1 and 2, as used throughout the figures and following detailed description, a terminal 700 and a personal computer (PC) 600 may have the same hardware and be connected to the same type of network structure. Each of terminal 700 and PC 600 may comprise single computing devices. For example, PC 600 may be a commercially available personal computer with one or more central processing units (CPUs). Alternatively, PC 600 may comprise multiple computing devices and/or computing functionality hosted on one or more servers (i.e., in a collection of servers such as a server cluster or server farm). However, to facilitate the explanation of the present invention, a terminal 700 shall refer to a public or semi-public, generic computer such as a library computer, school computer, or Internet cafe computer. Terminal 700 is designed to receive account information from a server 100 or a web server 500, and may have terminal software 23 installed in the memory 705 of the terminal. As used herein, the term PC shall refer to a private or semi-private, generic computer such a personal computer or a laptop.

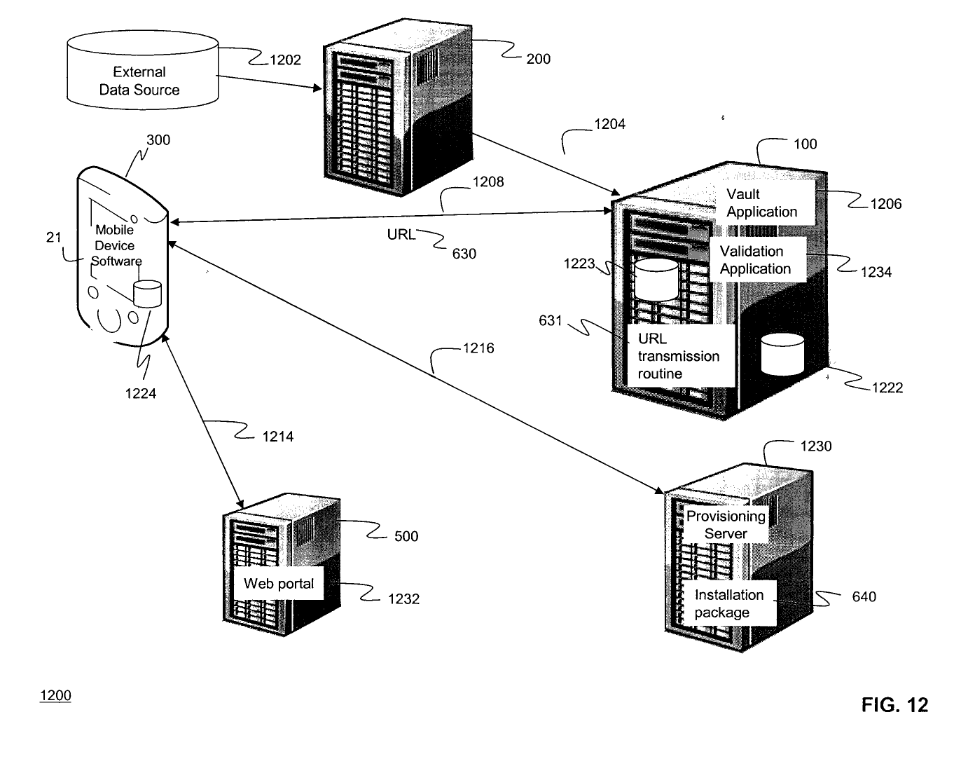

As used herein, the term “server” encompasses computing devices that are designed to function as one or more of application servers, database servers, file servers, key servers, web servers, and fax servers. A server may be comprised of one or more server machines. A server may be implemented as collection of servers such as a server farm or server cluster. For example server 100, web server 500, and provisioning server 1230 (FIG. 12) may be commercially available server machines with one or more central processing units (CPUs). Alternatively, these servers may comprise multiple computing devices and/or computing functionality hosted on multiple server machines (i.e., a server farm).

As used herein, the term “processor” is any electronic circuit that can execute computer instructions or programs. A processor may comprise one or more central processing units (CPUs). A processor may be implemented as multiple processors and their interconnections on a single silicon chip (i.e., a multi-core microprocessor).

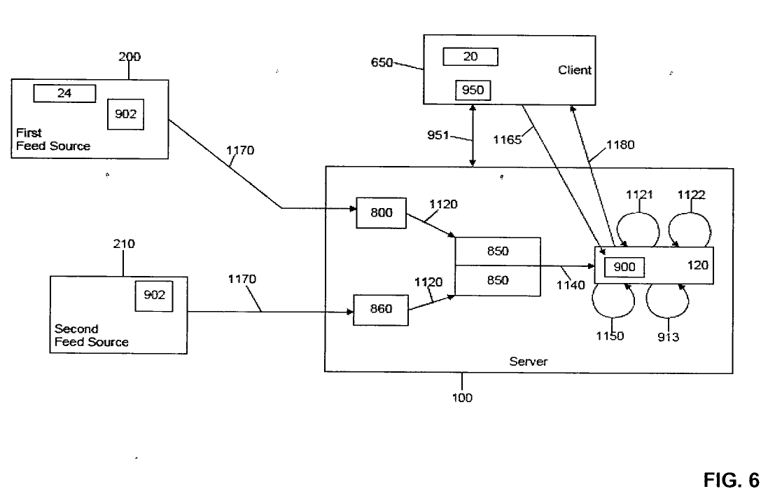

PC 600, client 650, terminal 700, feed source 200, server 100, and mobile device 300 may all comprise similar software running on the indicated hardware. However, in most instances a specially adapted version of the software will be installed on each of PC 600, terminal 700, feed source 200, server 100, and mobile device 300. For example, terminal 700 may have terminal software 23, PC 600 may have PC software 22, feed source 200 may have feed source software 24, and server 100 may have server software 26 (See FIG. 2). When referring to the software that runs on a client 650, reference numeral 20 may be used to designate that the client software 20 will be useful for all types of client 650 (See FIG. 6). PC 600 may have either mobile device software 21 or terminal software 23 installed. Alternatively, PC 600 may have both mobile device software 21 and terminal software 23 installed. In some embodiments a PC may have its own version of the software installed, the PC software 22.

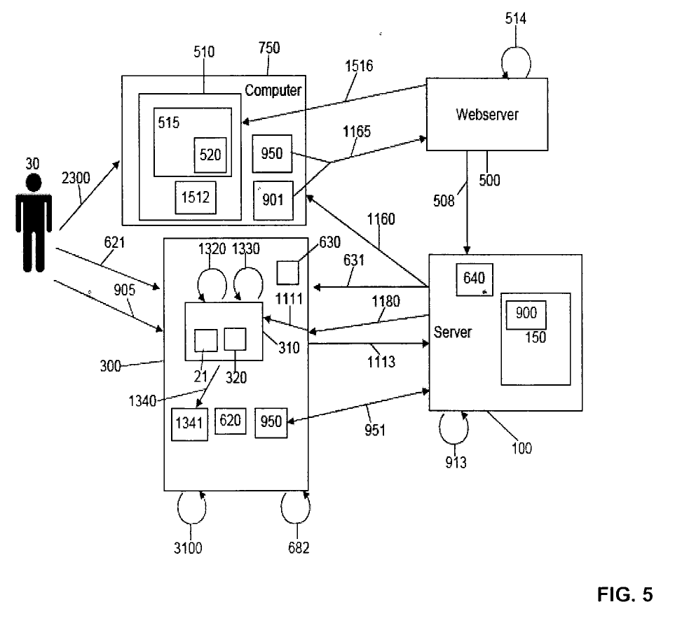

As used herein, the term “computer” 750 (a computer is shown in FIG. 5) encompasses PCs 600, terminals 700, and other clients that are designed to receive information from or transmit information to a server 100 or a web server 500. PCs 600, terminals 700, and mobile devices 300 are referred to generally as clients 650. A user's computer 750 used in an office or place of business may be classified as either a PC 600 or a terminal 700 depending on the level of access and the type of software installed.

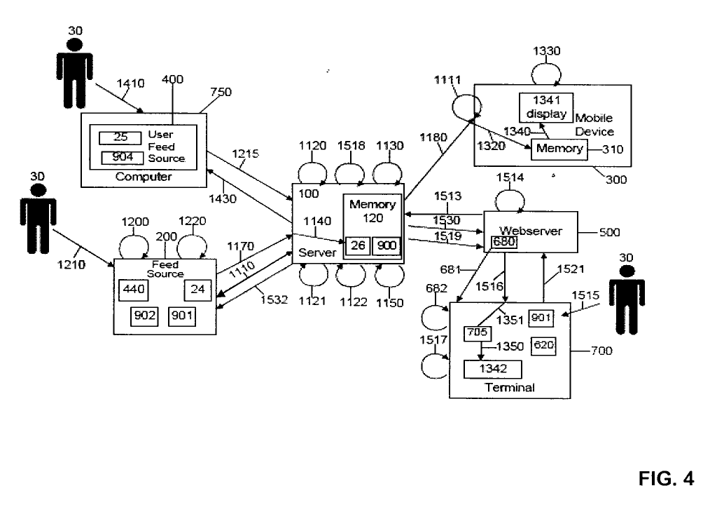

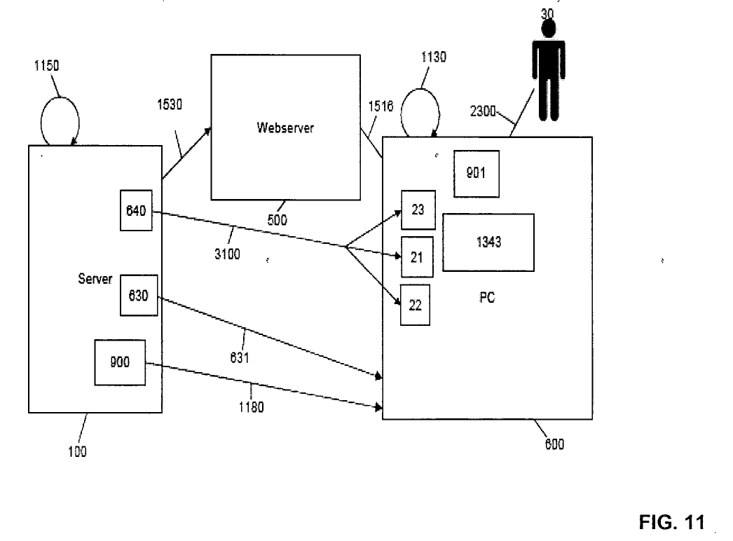

The present disclosure refers to three types of information, account information 900, identification information 901, and feed source information 902. Account information 900 may include information such as records, data, forms, and all other types of information in a user's account. A user account may include, for example, the information that a utility company, an employer, an insurer, a bank, a health care company, or a police department may have with regard to a particular user 30. Account information 900 may also include identification information 901 (See FIG. 4). Identification information 901 is a type of information that allows an administrator, computing machine, or user 30 to associate a particular user 30 or a client 650 with a particular set of account information 900. Common types of identification information 901 include, for example, social security numbers, usernames, customer numbers, electronic product code (EPC) numbers, birthdates, credit card numbers, passport numbers, Radio-frequency identification (RFID) tags, or account numbers. More than one type of identification information 901 may be used to uniquely determine which user 30 or client 650 corresponds to a given set of account information 900. Feed source information 902 refers to the information that is output by a feed source's output routine 1170 (See FIG. 11). When the type of information is not specified, the recitation of “information” herein shall designate any of these types of information, unless the syntax or subject matter of the sentence or claim requires an alternate understanding.

Unless specifically stated differently, a user 30 is interchangeably used herein to identify a human user, a software agent, or a group of users and/or software agents. Besides a human user who needs to access account information, a software application or agent sometimes needs to access account information. Accordingly, unless specifically stated, the term “user” as used herein does not necessarily pertain to a human being.

Finally, a user 30 and an administrator can be distinguished. A user 30 is a person, organization, business or other legal entity that uses the system 10 to view, obtain, modify, or distribute account information 900. Users are depicted in the figures as stick figures, 30. An administrator is a person, organization, business or other legal entity that oversees the operation of a feed source 200 and/or server 100. Administrators or their agents may add information or modify the information in a feed source 200. More generally, users 30 are entities that use the system 10, and administrators are entities that oversee the operation of the system 10 and its various components. Users 30 chiefly interface with the system 10 through the use of a client 650, whereas administrators chiefly interface with the system 10 through server 100, web server 500, or the feed source 200. Both users 30 and administrators may add, update, and view information in the system 10.

### The Electronic Information System

FIG. 1 shows an exemplary embodiment of system 10 of the present invention comprising an electronic information system having an information server 100 which distributes information from the memory 205 of a feed source 200 to the memory 310 of a mobile device 300, to the memory 605 of a personal computer (PC) 600, and/or the memory 705 of a terminal 700 interfacing with server 100 or a separate web server 500. The system 10 may also comprise a user feed source 400, which can send information to and from server 100. One of the purposes of the present invention is to transfer information from the feed source 200 to server 100 where the information may be processed, formatted, or merged. The information may then be transferred to mobile device 300, PC 600, or terminal 700 so that a user 30 (not shown in FIG. 1) can view the information.

FIG. 1 depicts eight major components of system 10, in accordance with an embodiment of the present invention: a first feed source 200, a second feed source 210, web server 500, server 100, user feed source 400, terminal 700, PC 600, and mobile device 300. Each one of these components may comprise a memory: i.e., a first feed source memory 205, a second feed source memory 215, a web server memory 505, a server memory 120, a terminal memory 705, a PC memory 605, a mobile device memory 310, and a user feed source memory 405. The memory in each of these components 100, 200, 210, 300, 400, 500, 600, and 700 may be used to store and retrieve information residing within each of the components.

Starting with the feed source 200, the feed source 200 may output information through the feed source output routine 1170 to server 100, which will in turn receive the information and may send it to web server 500 (via the transmission routine 1530), to mobile device 300 or PC 600 (via the server output routine 1180), or to the user feed source the present invention 400 (via the user feed source's download routine 1430). Mobile device 300 may in turn send information to the first and second feed source 200, 210 via the mobile device to feed source transmission routine 1533. Similarly, web server 500 may send information to the first or second feed source 200, 210 via the web server to feed source transmission routine 1531. Many of the components besides the feed source 200 can send information to server 100. In FIG. 1, web server 500 can send information to server 100 via a registration routine 1513, and user feed source 400 can send information to server 100 via a save request 1215. In embodiments of the present invention, clients such as terminal 700, user's computer 750, or mobile device 300 may be able to send information directly to server 100, though FIG. 1 does not illustrate those types of embodiments. However, terminal 700 in FIG. 1 can send information to web server 500 via a terminal to web server transmission routine 1521.

### The Server

As shown in FIGS. 1 and 4, server 100 of the present invention may be responsible for performing a host of storing, processing, receiving, and transmitting routines or tasks. Server 100 may comprise one or more physical machines (i.e., computing devices) having one or more processors 110. With the advent of distributed and parallel processing technologies, it is no longer necessary to have one server perform all processing and storage requirements that a given server system might require. Therefore, in the present invention a separate machine (another server) could perform many different functions. For example, a separate machine could handle each of the functions of encrypting information, storing information, receiving information, or transmitting information. These particular functions are illustrated in FIG. 4 as an encryption routine 1130, a storage routine 1140, a reception routine 1110, and a server to web server transmission routine 1530. These routines will be explained in more detail below. Moreover, more than one machine could be used to handle each of these tasks. In the following description, a separate web server 500 is often referenced, but web server 500 may be part of the same machine that performs tasks assigned to server 100.

### The Feed Source

As shown in FIG. 4, the feed source 200 comprises feed source software 24 that allows the feed source 200 to distribute information to server 100. The feed source software 24 may comprise an input routine 1210 that allows the administrator, user 30, or a content provider to input feed source information 902 into the feed source. An example of a content provider might be a third party that provides information to the feed source 200 for a fee. For example, The Associated Press is a possible content provider for news. Often the feed source information 902 contained within the feed source 200 may be provided by the operator or owner of the feed source 200 itself, such as a web blog. This information may be formatted via a feed source format routine 1200, which may contain specialized scripts or programs to alter the design, layout, or information stored or distributed by the feed source 200. The feed source 200 may use Really Simple Syndication (RSS) for providing content or information to server 100, but other protocols such as XML (Extensible Markup Language) may be used. The feed source 200 may store the formatted information via storage routine 1220.

The feed source 200 may have an output routine 1170, which outputs feed source information 902 such as source code, HyperText Markup Language (HTML), or other formatted information that is used to allow other programs or browsers to display the feed source information in different ways. The feed source 200 may also output identification information 901 through the same output routine 1170. The output routine 1170 may transmit the feed source information 902 or identification information 901 stored in the feed source 200 to server 100. (FIG. 6 also shows both the identification 901 and feed source information 902 being sent to server 100). As shown in FIG. 4, server 100 can request that the feed source 200 send this information through its output routine 1170. The information can be sent on predetermined intervals, or the feed source 200 can send updates when the server's reception routine 1110 requests new feed source information 902.

The feed source 200 may also be capable of receiving updates from server 100, web server 500, or client 650 (FIG. 6 depicts information flowing to client 650). Server software 26 running on server 100 may comprise a server to feed source transmission routine 1532 which allows server 100 to update feed source information 902 stored in the memory 205 (shown in FIG. 1) of the feed source 200. Though FIG. 4 does not illustrate any other routine that can update the information in the feed source 200, FIG. 1 illustrates a mobile device to feed source transmission routine 1533 and a web server to feed source transmission routine 1531. Additionally, a PC to feed source update routine (not shown), and a terminal to feed source transmission routine (not shown) may be implemented.

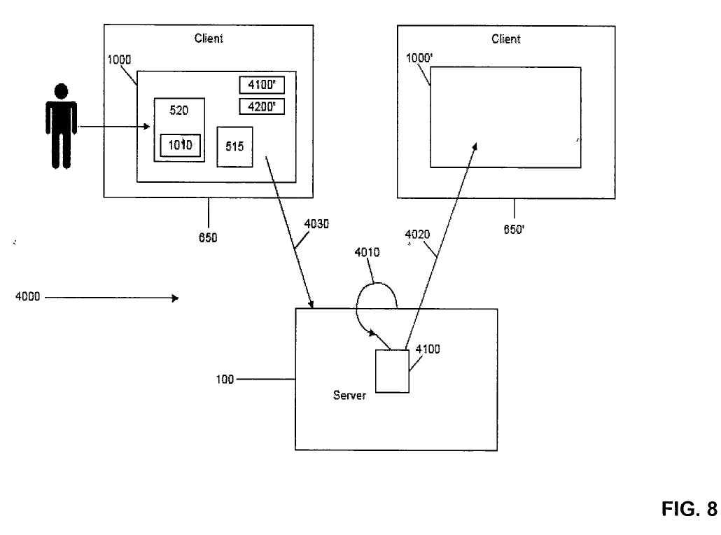

Referring to FIG. 4, there are various ways that account information 900 may be updated. Generally, information flows from feed source 200, to server 100, to mobile device 300 or terminal 700. However, as depicted in FIG. 1, information can also flow from mobile device 300 to second feed source 210; and as shown in FIG. 6, information can flow from client 650 to server 100. The administrators of feed source 200 may update the information contained in feed source 200. The source of the information may come from sources like the end user 30 of the system 10 itself, the administrator of server 100, news publications or corporate policies or documents, or the administrator of the feed source 200 itself. For example: user 30 of an embodiment of the present invention may send a change of beneficiary form to the feed source 200; the organization running the feed source 200 may wish to change its terms for credit card acceptance; or the server administrator may need to alert the feed source administrator of a duplicate record. These communications could be transmitted via conventional means such as fax, mail, or telephone, but it is also contemplated that the system 10 itself may provide additional update routines. Some embodiments of the present invention may allow a user 30 using a terminal 700 to update his or her account through changing information in a webform 520 (FIG. 8), or through uploading documents or forms. Similarly, a user 30 may be able to update this information using mobile device 300. Updates may be transmitted back to server 100 which may update the feed source 200, or updates may be transmitted to the feed source 200 directly. In the case of mobile device 300, the update may be saved locally until the next electronic exchange with server 100 takes place.

### The User Feed Source

As shown in FIG. 4, in some embodiments of the invention, user feed source 400 may be implemented to allow users 30 to access or modify their account information 900. For example, if user 30 wants to be able to view his medical, health care provider, or financial account information 900 for the user's business, he might create and operate a custom user feed source 400. Rather than requiring user 30 to invest in his own computer/network equipment and feed source software 24, the system 10 may be configured to allow user 30 to create a user feed source 400 comprising an input routine 1410. The input routine 1410 may provide him with a set of software tools 25 to allow user 30 to add, update, or view his user feed source information 904. In this example, user feed source information 904 may include information such as health care provider information, personal health record (PHR) data, sales information, notes, profit, suppliers, and customers. Server 100 may host and store this user feed source information 904 as account information 900.

There may be two major differences between the feed source 200 and user feed source 400. In a user feed source 400, the account information 900 may be stored on server 100 by sending server 100 a save request 1215 to save the account information using the server's storage routine 1140. During the operation of the save request 1215, the user's computer 750 uploads the account information 900 to server 100 where the account information 900 will be saved in the server's memory 120. As discussed above in the definitions section, a user's computer 750 may be classified as either a PC 600 or a terminal 700 depending on the level of access and the type of software installed.

To view the account information 900, user 30 would download information from server 100 using the user feed source's download routine 1430. In the regular (non-user) feed source 200, the feed source information 902 may be stored in the feed source's database 440. Additionally, with the feed source 200, an administrator may provide the feed source software 24 to maintain, create, and operate the feed source database 440 and the feed source 200. In many embodiments of user feed source 400, server 100 may provide user 30 with software tools 25 or other software to allow user 30 to create and manage his or her account information 900.

As shown in FIG. 4, server 100 may receive information from the feed source 200 and user feed source 400 or from a plurality of feed sources 200, 210 (See FIG. 6). Once the information is received, it can be stored in memory 120, processed via processing routine 1120, formatted via format routine 1121, and merged via merge routine 1122. Additionally, server 100 may implement a search routine 1518 and selection routine 1150 to locate particular account information 900. Server 100 may also be able to encrypt the information through an encryption routine 1130. The registration routine 1513 and notification transmission routine 1519 are explained later in the section outlining how terminal 700 is used.

FIG. 4 shows mobile device 300, web server 500, and terminal 700. The information received (via the mobile device reception routine 1111) from the server output routine 1180 may be saved in the memory 310 of mobile device 300 via the mobile device storage routine 1320. The information may be displayed on a display 1341 of mobile device 300 via a mobile device display routine 1340. If the information was encrypted by the server's encryption routine 1130, it may be decrypted by the mobile device decryption routine 1330.

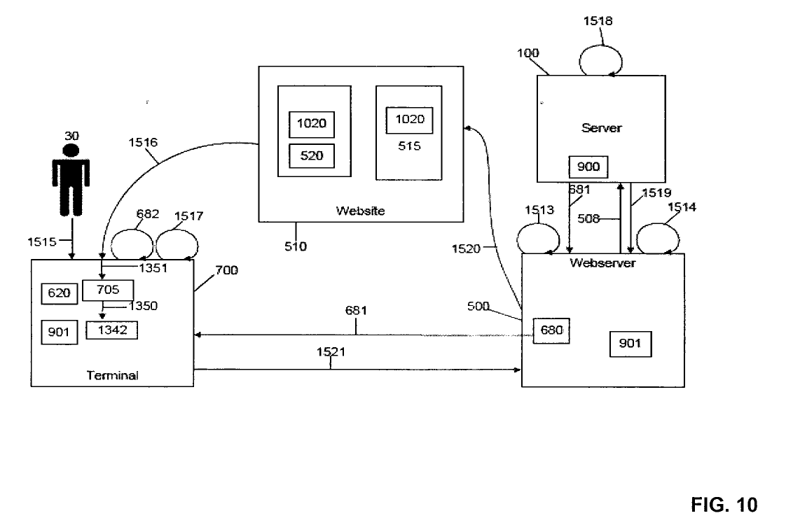

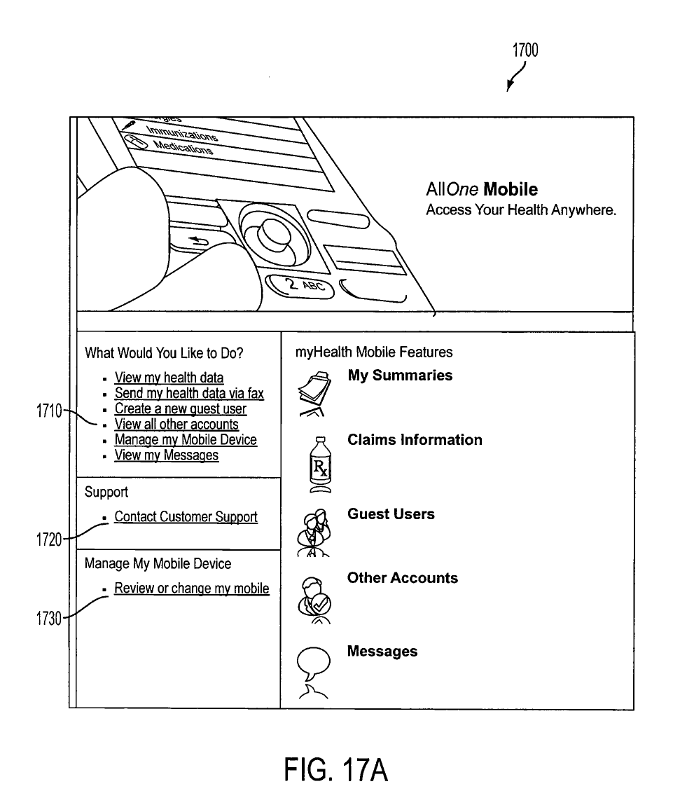

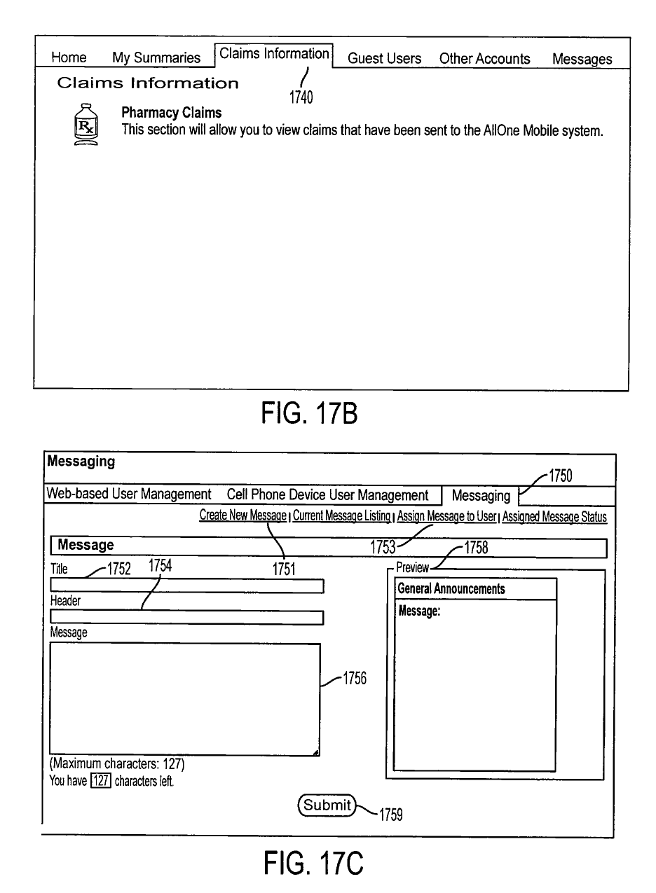

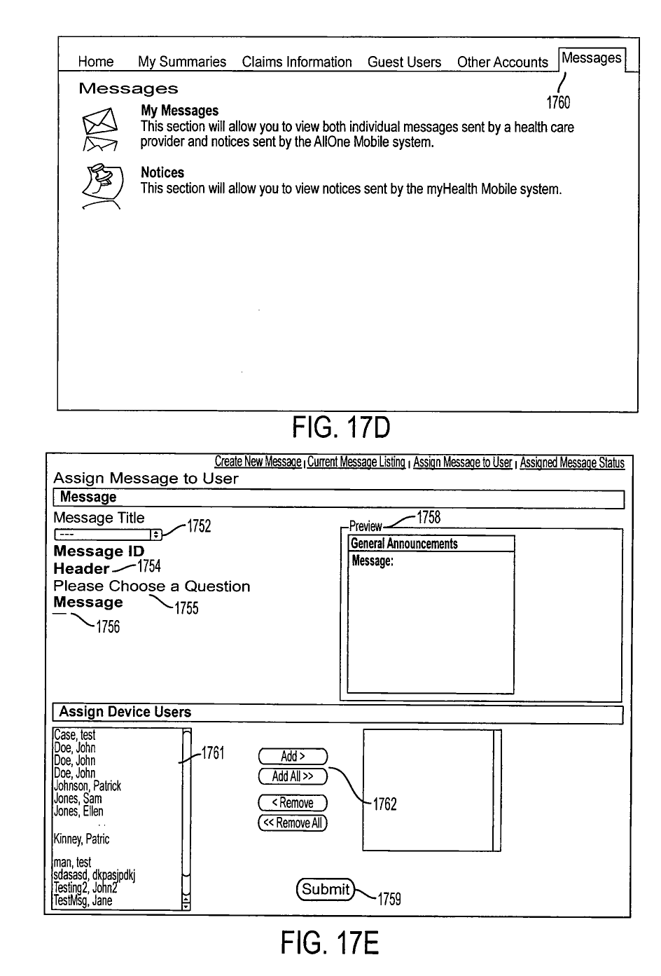

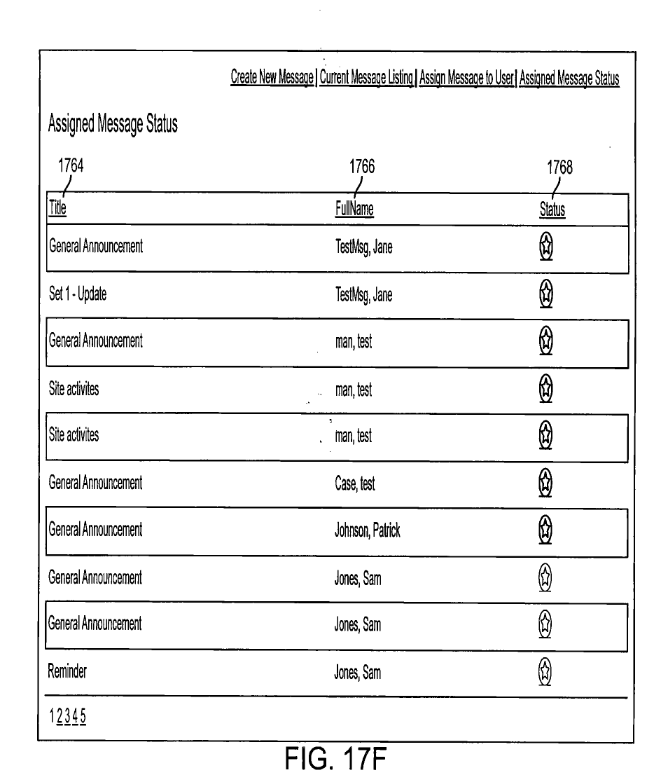

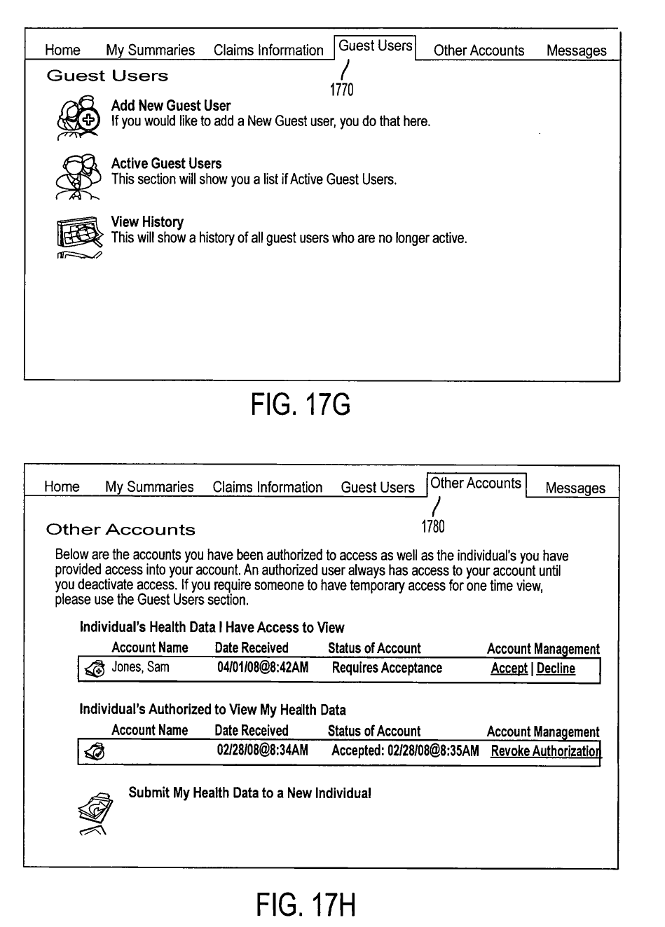

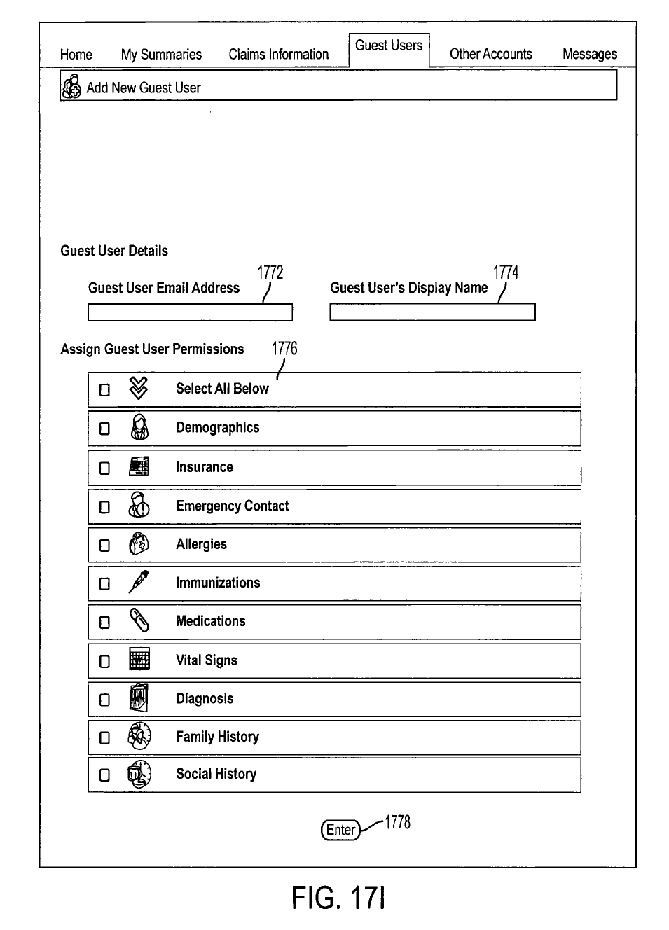

Server 100 can send information to web server 500 via the transmission routine 1530. Web server 500 may generate a web page, such as web page 515 depicted in FIG. 10, via a web page generation routine 1514. In an embodiment, web page 515 may comprise graphical user interfaces 1700 and 1800 depicted in FIGS. 17A-I and 18A-G, respectively. Web server 500 may output the information to terminal 700 via the web page transmission routine 1516. In an embodiment of the invention, terminal 700 may send information back to web server 500 using a terminal to web server transmission routine 1521. Terminal 700 can also receive information from user 30 via the terminal reception routine 1515. The information received from the web server web page transmission routine 1516 may be stored in memory 705 via the terminal storage routine 1351, and displayed on the terminal's display 1342. Terminal 700 may also decrypt the information via the decryption routine 1517.

### The Server and Multiple Feed Sources

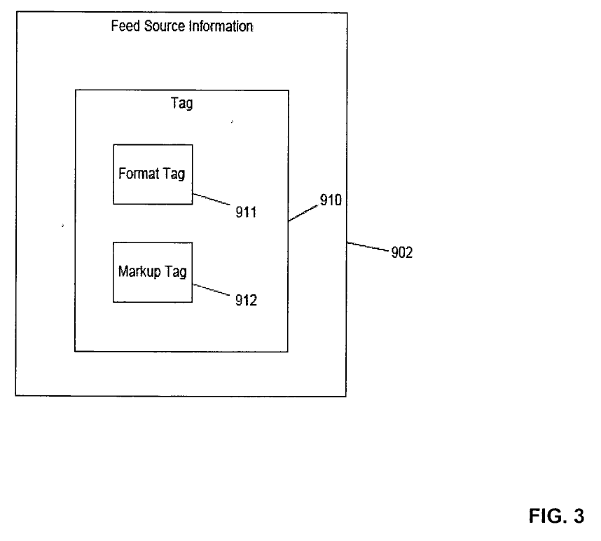

The system shown in FIG. 6 comprises a server 100 that may receive information from a first feed source 200 and a second feed source 210 that can distribute their feed source information 902 to the electronic information server 100. In accordance with an embodiment, more than two feed sources may be used. The information transmitted by the feed source 200 may comprise tags 910 to help server 100 process the information. See FIG. 3. FIG. 3 shows the types of tags 910 that may be included within the information sent from the feed source, such as format tags 911 and markup tags 912. Once server 100 has received the feed source information 902, it may store the information in its memory 120 using the server's storage routine 1140 (FIG. 6).

Referring again to FIG. 6, server 100 may also execute a processing routine 1120 (also shown in FIG. 4) which allows server 100 to manipulate or process the feed source information 902. In some embodiments, the processing routine 1120 will convert the information from a first format 800 and second format 860 into a third, final format 850. Additionally, server 100 may have a format routine 1121 and a merge routine 1122 as well. The processing routine 1120 may allow server 100 to convert languages such as HTML to text, rich text to XML, change the programming language such as C++ to Perl, or Java to ASP, add or remove formatting characters, instructions, or codes, or rearrange information. The format routine 1121 may allow server 100 to change the style, format, or layout of the output of the processing routine. The merge routine 1122 can be used to concatenate two or more related sets of feed source information 902.

As an example, the first feed source 200 outputs a first format 800 of feed source information 902. In one embodiment of the feed source 200, the feed source 200 may output the Java code shown in Table 1.

TABLE 1

/*Java*/
class HelloWorldApp {

public static void main(String[ ] args) {

System.out.println (“<HTML><body>”);
System.out.println (“Patient X was diagnosed
with cancer on April 1, 1999.”);
System.out.println (“</body></HTML>)”;

}

}

The second feed source 210 may output feed source information in a second format 860, which might be, for example, a Perl script as shown in Table 2.

TABLE 2

#Perl
print “<HTML><body><i>\n”;
print “Patient X saw Oncologist Y on April 1, 1999.”; print
“</i></body></HTML>\n”;

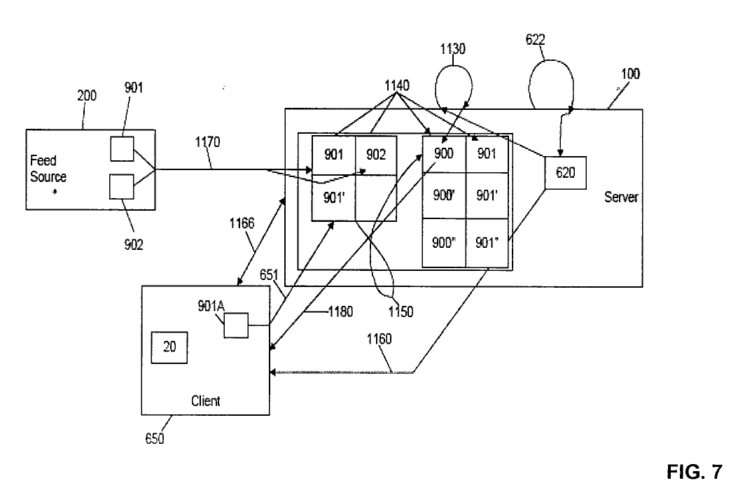

The example information from the first feed source 200 is Java source code that would cause an interpreting computer to output the HTML code for a browser to display an HTML web page specifying some of Patient X's heath history. The example information from the second feed source 210 is generated via a Perl script, which also specifies the HTML code for a browser specifying health information about Patient X. As explained previously, feed source output routine 1170 may also transmit identification information 901 (See FIG. 7) which may be used by the selection routine 1150 (FIG. 6) to correlate a particular user 30 (or his or her client) with his or her account information 900.

The processing routine 1120 (FIG. 6) can change the output of the feed sources 200 and 210 dramatically. Rather than having the client manipulate the feed source information 902 into a format that is it can use (i.e., final format 850), server 100 can process the feed source information 902 using the processing routine 1120, format routine 1121, and merge routine 1122.

In the embodiment shown in FIG. 6, client 650 may expect to receive information in the rich text format. In embodiments of the present invention, final format 850 could be XML, HTML, RSS, text or other formats. Therefore, the processing routine 1120 must convert both the output of the Java code (the first format 800) of the first feed source 200 and the output of the Perl script (the second format 860) into rich text (final format 850). In other embodiments, the feed sources 200, 210 may output text, HTML, rich text, or other formatted languages.

Referring to FIG. 3 in conjunction with FIG. 6, format tags 911 maybe used to tell the processing routine 1120 the format of the current feed source 902. This allows the processing routine 1120 and format routine 1121 to convert the formats of the different feed sources 200, 210 into one common format (such as rich text for example). FIG. 3 illustrates some of the components of the feed source information. Additionally, server 100 may comprise a list of available formats a particular client can interpret. In some embodiments, client 650 may inform server 100 which types of formats it can receive or would like to receive. For example, a PDA may be capable of displaying PDF documents, text documents, HTML, and RSS; whereas a cell phone might require a text document or a proprietary Nokia® or Motorola® text format. The output determination routine 913 (FIG. 6) determines which formats the intended client 650 will receive. In an embodiment, output determination routine 913 formats the output depending on output formats client 650 is capable of displaying. Output determination routine 913 may also use a database to determine available formats, or it may look up the information online. In the above example, the format tag “Java” tells the processing routine 1120 that the feed source 200 outputs Java code. Additionally, the presence of tags called markup tags 912 may tell the routine 1120 that the output of the Java code is HTML code as depicted in FIG. 3. In addition to markup tags 912 and format tags 911, different computer codes or languages may comprise other types of tags. All of these different types of tags may be generally referred to as tags 910 as depicted in FIG. 3. Use of tags 910 is optional, and the invention may be practiced without them. Without the use of tags 910, the processing routine 1120 may use heuristics to determine the format of the output. Alternatively, the processing routine 1120 may require human input to determine format of the feed source information 902, or the format may be hard coded into the processing routine 1120.

Using rich text (or other formatted languages like XML or HTML) allows the processing routine to generate final format 850 using particular text attributes. For example, the Calibri font may be used. One way to output the code from Table 1 into rich text is shown in Table 3A.

TABLE 3A

{\rtfl \ansi\ansicpg 1252\deffO\deflang 1033 {\fonttbl
{\f1~\fswiss\fprg2\fcharset0
Calibri; } } \viewkind4\ucl\pard\fn\fs22\ldblquote
Patient X was diagnosed with cancer
on April 1, 1999.\rdblquote\par}

This text format, called the rich text format, when processed by a rich text interpreter (which would be part of the client's software 20, as shown in FIG. 2) would output, “Patient X was diagnosed with cancer on Apr. 1, 1999.” Naturally, there are simpler ways to output such a simple message, but rich text also allows for a variety of other formatting, such as bold facing (see Table 7 below, for an example).

To generate this rich text code (i.e. to convert Table 1 into Table 3A), the code for the processing routine 1120 would actually need to be written. Exemplary code of the processing routine 1120, format routine 1121, and the merge routine 1122 (written in Perl pseudo code) is shown in Table 3B:

TABLE 3B

| 1. | my $input= getFeedSourceInformation( ); my $answer; my |
|---|---|
| | $inputl= getIdentificationInformation( ); |
| 2. | my $X= main($input); |
| 3. | sub main( ) { |

| | |
|---|---|
| 4. | do{ |
| 5. | $answer=isTheOutputComputerCode($input); |
| 6. | if ($answer) { |
| 7. | determineLanguage( ); |
| 8. | runAppropriateCompilerO; |
| 9. | $input =executeCompiledCodeO; |
| 10. | saveFormattingO; } |
| 11. | } |
| 12. | while(isTheOutputComputerCode($input)); |
| 13. | return $input; } |

| 14. | my $table= “{\\rtfl\\ansi\\ansicpg1252\\deff0\\deflang1033 |
|---|---|
| | {\\fonttbl{\\fO\\fswiss\\ |

fprg2\\fcharset0 Calibri; } } \\viewkind4\\uc 1
\\pard\\fly\\fs22\\“.$X.”\
\par} ”;
# the double “\\” must be used so that the Perl interpreter
will interpret the #slashes as slashes, and not as the
escape character ‘\’.

| | |
|---|---|
| 15. | format($table); |
| 16. | runSelectionRoutine($input); |
| 17. | save($table); |
| 18. | output($table); |

The exemplary code of Table 3B is one way to program the instructions for the processing routine 1120 (FIG. 6). As one skilled in the art would quickly recognize, the code in lines 1-18 of Table 3B is sufficient merely to explain to a programmer how to write the code for the processing routine 1120, format routine 1121, and merge routine 1122. All of the methods called by main( ) are undefined, but a programmer skilled in the art could write the rest of the code, when provided with the following explanation.

In line 1, the program stores the input from the feed source 200 from the feed source output routine 1170 and saves it as the variable $input. Line 1 also declares the variable $answer. Also shown in line 1, there is a command to save the identification information 901.

In line 2, the program stores the data returned by the method main. This step also causes the method main to be executed.

Line 3 line specifies that lines 3-13 are the method main( ).

Line 4 causes the program to execute a do/while loop.

Line 5 saves the result of the method “isTheOutputComputerCode( )” as the variable $answer. In this example, the output of the method “isTheOutputComputerCode( )” is a boolean (1=yes, 0=no). The method itself, is TheOutputComputerCode( ), may use some type of heuristic analysis to determine whether or not $input is computer code. The method may also utilize a tag 910 (which in Table 1 is /*Java*/ or #Perl in Table 2) to determine whether the $input is computer code. The method then returns a zero or a one depending on whether or not the method determined $input is computer code. The result is saved as $answer.

In line 6, if $answer is true (i.e. equal to 1), lines 7-10 are executed.

In line 7 the method, determineLanguage( ), determines the language of the code. This method might look for specific markers to determine the language of the code. For example, System.out.println is a command for printing in a Java program. The method could make the determination that a program having this command is a Java program. Because many languages share similar commands (such as “if”) certain commands will be more useful for determining the language of the code than others. Additionally, the text saved as $input may tell the Java interpreter to import specific packages which might also indicate the language of the code. Also, tags 910 may be used to aid the determinelanguage method. For example, the tag, /*Java*/ not only indicates, that the text is computer code, but it can also inform the processing routine 1120, that following code is Java source code, obviating the need to use a lookup table or a heuristic analysis to determine the language of the code.

In line 8, “runAppropriateCompiler( )”, calls a method which causes the appropriate compiler to compile $input. For Table 1, the program would call a Java compiler to convert the Java source code into Java byte code. For example, the program might execute the command “javac firstformat.java”. In Table 2, the program would determine that there is no compiler for Perl (since Perl is a scripting language), and exit the runAppropriateCompiler( ) method.

In line 9, the executeCompiledCode( ) method would execute the code compiled in line 8 and save the output as $input. To execute the compiled Java code, the appropriate command (such as “Java firstformat”) would be executed. For the Perl script, the command would be “Perl secondformat.pl”. In either case, the executed code is saved as $input. Table 4A shows the output that would be saved as $input for the feed source information 902 in the first format 800, and Table 4B shows the output that would be saved as $input for the feed source information 902 in the second format 860.

TABLE 4A

<HTML><body>
“Patient X was diagnosed with cancer on April 1, 1999.”
</body></HTML>

TABLE 4B

<HTML><body> <i>
“Patient X saw Oncologist Y on April 1, 1999.”
</i></body></HTML>

Line 10, in some cases, the compiled code specifies attributes of how $input should appear. In the first format 800, there is no special attributes specified by the code. In the second format 860, $input is given the attribute of italics. The italicization information is specified in the markup tag 912 <i> shown in Table 2 (also see FIG. 3.) The value and location of the markup tag may be saved in server's memory 120 and used by the format routine 1121. (Also see line 15.)

Line 11, simply ends the block of code executed when the if statement evaluates as true.

Line 12, in some cases the output of computer code in line 9 will be text. In those cases, the while loop tests false, and the program proceeds to line 13. In other configurations, the output of the code could be more computer code, such as HTML. In these cases, the program repeats lines 4-11. When executed a second time, the value saved in $input is shown in Table 5.

TABLE 5

“Patient X was diagnosed with cancer on April 1, 1999.”

Line 13, causes $input to be saved as $X, which is the account information 900 in FIG. 6.

Line 14, concatenates the information from Table 3A with the string $X to form the output string that will be generated by the server's output routine 1180. An output determination routine 913 is shown in FIG. 6. The routine determines the types of output compatible with the client. The code shown in lines 1-18 does not utilize an output determination routine 913; rather the conversion to rich text is hard coded. However, if output determination routine 913 is implemented, server 100 could request the client send a device identifier 950 to server 100 via the device identifier transmission routine 951. A device identifier 950 may be information such as a serial number, model number, EPC number, or other code that can identify the type of device constituting the client.

Line 15, calls the format method, which can modify the output string currently saved as $table. In some cases, this method will determine whether any markup tags 912 specify the formatting of the output. In other cases, a default or a user-selected format may be applied by the formatting routine 1121 in FIG. 6, for example.

Line 16, calls the runSelectionRoutine (the selection routine 1150) to associate a user 30 (or his or her client) with the account information 900. The process by which the selection routine 1150 works is explained below with reference to FIG. 7.

Line 17 stores the account information in memory (server storage routine 1140).

Line 18 outputs the string to the client via the server output routine 1180. The final output created by the feed source information 902 of the first format 800 is shown in Table 6. In an embodiment of the invention, the string could be output to a printing device such as laser jet printer.

TABLE 6

{\rtfl\ansi\ansicpg1252\deffn\deflang1033
{\fonttb1{\fD\fswiss\fprg2\fcharset0 Calibri; }}
\viewkind4\ucl\pard\fD\fs22\ldblquote Patient
X was diagnosed with cancer on April 1,
1999.\rdblquote\par}

If format routine 1121, were programmed to specify a bold font, the bold switch could be selected by adding \b to the above example (shown in bold to add contrast).

TABLE 7

```
{\rtfl\ansi\ansicpg1252\deffD\deflangl033 {\fonttb1
{\fD\fswiss\fprg2\fcharset0 Calibri; }}
  \viewkind4\ucl\pard\b\fD\fs22\ldblquote Patient
X was diagnosed with cancer on April 1,
  1999.\rdblquote\b0\par}
```

Saving this output in memory 120 of server 100, the processing routine 1120 could then collect the output of the second format 860 (Table 2) in a similar manner. The second format 860 is written in Perl and also has the markup tag 912 <i>. Markup tag 912 may be used by the output by the format routine 1121.

Applying both processing routine 1120 and format routine 1121 to the second format 860 yields Table 8.

TABLE 8

“Patient X saw Oncologist Y on April 1, 1999.”

In some cases, the server's selection routine 1150 can determine that two outputs from one feed source 200 (or one output from two different feed sources 200, 210) contain related information that can be merged into one transmission. The selection routine 1150 may rely on tags 910 to make this determination, or use other heuristic techniques to determine that both sets of account information 900 contain related information. In these cases, the merge routine 1122, can concatenate the information into one set of account information. Notice how only one set of account information 900 appears in FIG. 6. This is because the merge routine 1122 merges both sets of feed source information 902 into one set of account information 900. For the exemplary embodiment involving Java and Perl code, the rich text output is shown in Table 9.

TABLE 9

{\rtfl \ansi\ansicpg 1252\deffD\deflang 1033 {\fonttb1
{\fD\fswiss\fprg2\fcharset0
Calibri;} }
\viewkind4\ucl\pard\b\f0\fs22\ldblquote Patient X
was diagnosed with cancer on April 1,
1999.\rdblquote\par\b0\i\ldblquote Patient X saw
Oncologist Y on April 1,
1999.\rdblquote\par\i0 }

By taking the output of two different feed sources 200, 210 each with its own format and converting them into one format that is expected by the software 20 installed on client 650, the client will be easily able to display information from different feeds sources 200, 210 utilizing different formats. Table 8, when viewed through a rich text interpreter (which would be resident in the client's software 20 in this example) would yield Table 10.

TABLE 10

“Patient X was diagnosed with cancer on April 1, 1999.”
“Patient X saw Oncologist Y on
April 1, 1999. ”

Naturally, the server format routine 1121 can further adjust the formatting or layout to make the output easier to read.

The above example shows how server 100 can convert the different outputs from two different feed sources 200, 210. As discussed previously, the feed sources 200, 210 could output HTML, XML, XHTML, SQL, RSS, ASP, text, or other formats, as well as any type of computer code. Similarly, server 100 can covert the received information from any of these formats to any particular format desired such as HTML, XML, XHTML, SQL, ASP, or text. Further, it is contemplated that client 650 could do part or all of this processing, formatting, and merging.

### The Encryption Routine

As shown in FIG. 7, for certain types of account information 900 it may be preferable to encrypt the account information 900 so that a third party cannot gain access to a particular user's account information 900. The development of a functional encryption scheme is complicated by the fact that a particular user 30 may have several different accounts which have different information. On client 650, one client software program 20 may be able to display all of the user's account information 900 from various feed sources 200, 210, or separate software programs may be used to display the output from the different feed sources 200, 210. In other embodiments, certain feed sources may be collected into one feed source, such as health information from different physicians could be collected into one feed source information set 902. A basic algorithm to accomplish the encryption scheme is described below.

A first set of feed source information 902 is sent by the feed source 200 to server 100. Server 100 may generate (using an encryption key generation routine 622) an encryption key 620, which may take the form of a string or a number. Using key 620, server 100 encrypts the feed source information 902 using an encryption method, such as an encryption system conforming to AES or Rijndael standards. In addition, software commercially available from companies such as Diversinet Corporation of Toronto, Canada or Data Encryption Systems may be used. Either way, the encrypted information is stored in memory 120 of server 100. The information can be stored in various ways such as storing the information in a relational database or a data store. Server 100 may also transfer key 620, using a key transmission routine 1160, to a client 650 so that client 650 can decrypt the information. In accordance with an embodiment of the invention, key 620 may be transmitted to a client 650 other than the client that will eventually use key 620 (not depicted in FIG. 6). Other methods for transmitting key 620 such as postal mail, fax, or telephone may be used. In alternative embodiments, server 100 could transmit key 620 to a computer interfacing with server 100, while key 620 will be for the use of a mobile device 300 (not shown in FIG. 7). Use of the encryption routine 1130 is an optional feature of the present invention, even though it is a highly useful feature for protecting account information 900.

FIG. 7 also shows the feed source 200 outputting feed source information 902 and identification information 901. Server 100 may store the information in memory 120, via storage routine 1140. When the feed source information 902 is stored, it may be stored as account information 900. As explained previously, the feed source information 902 may be processed before it is saved. The originally-received feed source information 902 may be deleted after it is saved as account information 900.

In some embodiments of the present information, server 100 will transfer account information 900 from the server's memory to client 650. The account information 900 is sent via the server's output routine 1180. However, FIG. 7 also shows second account information 900′ and third account information 900″ in memory 120 of server 100 (these sets of account information 900′, 900″ also have corresponding identification information 901′ and 901″). To send the client the correct information server 100 may request (via the server client request routine 1166) that client 650 send some identification information 901A to server 100 via the client output routine 651. Server 100 can use its selection routine 1150 to associate the corresponding account information with the relevant identification information 901. To perform this function, server 100 may need to invoke a search routine 1518 (not shown in FIG. 7, but see FIG. 4) to determine which set of account information corresponds to the provided identification information 901′. Server 100 then sends the selected account information 900 to client 650 via server output routine 1180.

### Viewing the Information

Referring again to FIGS. 1, 2 and 4, a user 30 of the present invention may use a client 650 such as PC 600, terminal 700 or mobile device 300 to retrieve and display account information 900 sent from server 100. As explained previously, client 650 can take the form of a portable or mobile device 300 such as a mobile phone, PDA, mp3-player, smart phone, or a laptop (collectively the “mobile device” embodiment described below). The client may also be embodied as user's computer 750 or a terminal 700 connected to a web server 500. In many embodiments, client 650 will be the device a person uses to view the information. There are three chief exemplary embodiments that a client 650 can assume: the mobile device embodiment, the terminal embodiment, and the PC embodiment (See FIG. 2), and in one system 10. One or more of these embodiments may be used. These three embodiments will now be discussed sequentially.

### 1) Mobile Device Embodiment

Referring now to FIG. 5, in the mobile device embodiment, mobile device 300 may have mobile device software 21 installed in the memory 310 of the device. Mobile device 300 may be any wireless mobile device such as a mobile phone, a personal digital assistant (PDA), a smart phone, a hand held computer, a palmtop computer, an ultra-mobile PC, a device operating according to the Microsoft Pocket PC specification with the Microsoft Windows® CE operating system (OS), a device running the Symbian OS, a device running the Palm OS®, a Blackberry® device, a T-reo®, or an iPhone®. Mobile device software 21 may be downloaded from a remote machine and installed through an installation routine 3100, preinstalled on the device, or installed through a flash card, CD, or other conventional methods.

### Using the Installation Routine to Install the Mobile Device Software

The installation routine can be used to install the mobile device software 21. The provider of mobile device software 21 may maintain a website 510 from which user 30 can download the software. The website 510 may be hosted by server 100, web server 500, or another server that can transmit web information. In the embodiment depicted in FIG. 5, the website is hosted by the web server. The website 510 allows user 30 to log into his or her account using the website or, if user 30 is new, create a new account.

As illustrated in FIG. 5, website 510 may have a registration web page 1512 and other web pages 515 within it. The web pages 515 may resemble corporate web pages such as those hosted by Aetna, Blue Cross, Bank of America, Scottrade, or Fidelity, except website 510 will have the option to allow a user 30 to setup his/her mobile device 300 (or other client) through a registration routine 2300.

With continued reference to FIG. 5, website 510 may offer user 30 an option to visit the registration web page 1512. The web page 515 may request that user 30 enter identification information 901 such as his/her name, email address, password, or username. Additionally, user 30 may also be required to submit a device identifier 950 such as the phone number of mobile device 300, service provider of the device, model of the device, serial number of the device, etc. As mobile device 300 may also send the device identifier 950 using a routine called the device identifier transmission routine 951, or server 100 may request the device identifier 950 be sent via the same device identifier transmission routine 951. In other embodiments, the identification information 901 or the device identifier 950 may be sent from web server 500 using the client transmission routine 1165. To transmit information to web server 500, user 30 would cause the browser software of the user's computer 750 to receive a web page 515 having a webform 520 from web server 500 through the web page transmission routine 1516. Web server 500 may generate the web page 515 via the web page generation routine 1514. Web server 500 may send the information it receives to server 100 via a routine called the web server to server transmission routine 508. The device identifier 950 may be used by output determination routine 913 to determine the syntax of the final format (such as rich text or HTML.)

The registration web page 515 (and the website 510) may employ SSL or other encryption technologies to increase security. Server 100 may also transmit a URL 630 to mobile device 300 using a URL transmission routine 631. Uniform Resource Locator (URL) 630 is simply an address of a remote machine (could be the address of server 100, web server 500, or provisioning server 1230) hosting an installation package 640 for the mobile device software 21 (See FIGS. 11 and 12). Installation package 640 may contain the setup routines to allow user 30 to install mobile device software 21. Referring to FIG. 11, other software types (terminal software 23, PC software 22, etc) may have their own installation packages. Using the URL 630, mobile device 300 can download installation package 640.

Once installation package 640 is downloaded, user 30 can install the mobile device software 21 by executing installation package 640, which invokes the installation routine 3100.

Once executed, installation package 640 running on mobile device 300 may request that user 30 enter the encryption key 620. This process is shown in FIG. 5 as the key entering step 621. User 30 may have received key 620 via key transmission routine 1160 (shown in FIGS. 5 and 7). Also, installation package 640 may request that user 30 enter a user name and password (or other identification information 901) via the identification information entering step 905 (not shown). In some embodiments, the username and password may be preset by server 100 to a default value, or to a specified value specified by user 30 during the registration routine 2300. The username and password (or other equivalent security mechanism) may be used to restrict access to mobile device software 21 to those users who know the username and password, whereas the encryption key 620 is required to decrypt the information stored in the database 320 of mobile device 300. Once mobile device software 21 is installed, user 30 can run the mobile device software 21.

### Using the Mobile Device Software

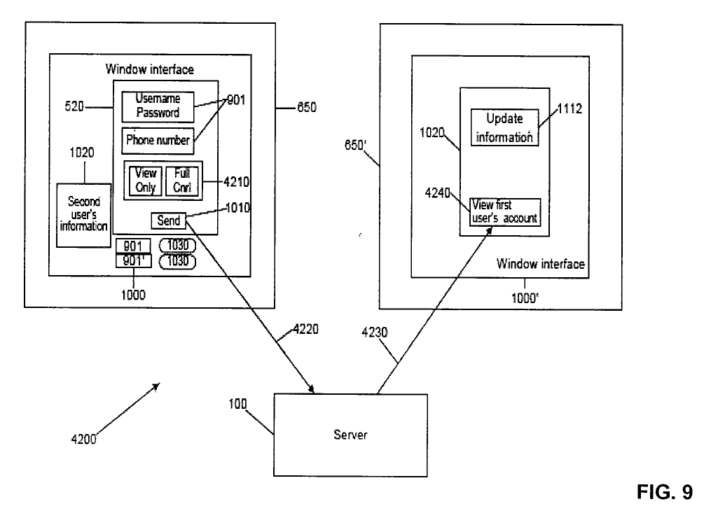

When the mobile device software 21 is initially installed, in many embodiments, the mobile device's database 320 will be empty or populated with default information. According to an embodiment, server 100 may pre-populate the mobile device database 320 with the information from the database 150 of server 100. Mobile device software 21 may allow a user 30 to view a number of screens or dialog boxes. Executing mobile device software 21 causes mobile device 300 to run a display routine 1340 to display the user's account information 900 on the mobile device display 1341. Mobile device 300 may also use a decryption routine 1330 and a storage routine 1320 to display the output of server 100. The display routine 1340 may display one or more windows 1020 (FIG. 9) which may comprise a reception button or icon 1112 (FIG. 9) to initiate a routine called the reception routine 1111 (FIG. 5), which enables mobile device 300 to receive account information 900 from server 100 which will be used to populate the database 320 of mobile device 300. Running the reception routine 1111 may cause mobile device software 21 to establish a connection with server 100 to download new information, or there may be a separate connection routine 1113 with connection settings to allow the mobile device to connect with server 100 (FIG. 5). Moreover, initiating the reception routine 1111 (and possibly the connection routine 1113) will cause server 100 to output the information through a server output routine 1180, which outputs the account information from the database 150 of server 100.

### 2) Using the Terminal to Access Account Information

A terminal 700 can be used to view account information 900 much the same way a mobile device 300 can be used (See FIG. 10). A similar installation procedure can be followed to allow user 30 to download an installation package 640 (See FIG. 11) so that user 30 can install mobile device software 21 on a terminal, and use mobile device software 21 to view his or her account information 900 on terminal 700. However, in most instances, a terminal 700 will be used in a public or semi public place, and saving the account information 900 (even if encrypted) is not desirable on terminal 700. Therefore, for most applications, terminal 700 will interface with a web server 500 (or server 100) to distribute and receive account information 900 (FIG. 10.) While the web server embodiment will be described in detail, an embodiment using just server 100 of FIG. 1 could be constructed. Server 100 in an embodiment which does not use a web server 500 would fulfill both server 100 and web server 500 roles.

Web server 500 hosts a website 510 containing web pages 515. See FIG. 10. Each web page 515 may contain one or more windows 1020 or webforms 520. See FIG. 10. User 30 of terminal 700 will interface with web pages 515 using a web browser (not shown). To view or modify a user's account information 900, user 30 enters a web address into the terminal's web browser, which allows terminal 700 to receive the web pages 515 through web server's web page transmission routine 1516. The web address is the URL of web server 500. The first time a particular terminal 700 accesses the web server's web page 515, web server 500 may transmit a web program 680 to be downloaded from server 100 (or web server 500) via a web program download routine 681. Installation of the web program 680 may be initialized using a web program installation routine 682. See FIG. 10. The web program 680 may be an applet, ActiveX control, Internet browser, or other software designed to interface with web server 500 or the web server's web pages 515. The web program 680 may initiate a terminal reception routine 1515 wherein the routine requests user 30 to enter the encryption key 620 and identification information 901. The web program 680 may cause a webform 520 to appear on the display 1342 of terminal 700, (via the terminal display routine 1350) prompting user 30 to enter key 620 and identification information 901. Terminal 700 may transmit the identification information 901 to web server 500 (using the terminal to web server transmission routine 1521). In some embodiments, key 620 may also be sent, but in other configurations key 620 is retained on terminal 700.

Once the identification information 901 is received, a registration routine 1513 for associating the user's account information 900 with his or her identification information 901 may be executed by web server 500. To create this association, web server 500 may send the identification information 901 to server 100; (via the web server to server transmission routine 508). Server 100 may then search its database 150 (using its search routine 1518) to determine whether there is account information 900 which is associated with the received identification information 901.

If the search routine 1518 identifies corresponding account information 900, server 100 may send the account information 900 to web server 500, using the server transmission routine 1530 (FIG. 11). Once web server 500 has the account information 900, it may generate a web page 515 using a web page generation routine 1514 if web server 500 has the encryption key 620, or the account information 900 is unencrypted. Web server 500 may transmit the generated web pages 515 to website 510 via the web server to website transmission routine 1520. If the account information 900 is encrypted and web server 500 does not have the encryption key 620, web server 500 may simply transmit the encrypted information to terminal 700. The web program 680 running on terminal 700 may receive the encrypted information, decrypt the information by using the encryption key 620, and display the information using a terminal display routine 1350. If user 30 does not have any account information 900 associated with the identification information 901, server 100 may transmit a notification (using a notification transmission routine 1519) to the web server that no account information 900 could be found. Upon receipt of this transmission, web server 500 may request that user 30 provide account identification 900, notify user 30 that the account information 900 was not recognized, and/or create a new account based on the identification information 901.

Terminal 700 which receives the account information 900 (and the web page 515 in certain embodiments) may store the account information 900 (and perhaps the web page 515) in memory 705. Terminal 700 may use key 620 to decrypt the information using a terminal decryption routine 1517. Having the non-encrypted account information 900 in memory 705, the web program 680 or browser may display the information using the terminal display routine 1350. Terminal 700 may also store the information using a terminal storage routine 1351. Using the terminal display routine 1350, terminal 700 may show or display the account information 900 on a screen, projection, or a display 1342.

The web page 515 visible to user 30, may be programmed using basic HTML or using a number of complex languages such as C++, Java, Perl, and may take the form of a program, applet, script, or an ActiveX control. In the embodiment just described, terminal 700 does not need to send key 620 to web server 500. By maintaining key 620 on terminal 700, security will likely be stronger than an embodiment where key 620 is sent to web server 500 along with the identification information 901.

### 3) Using the PC to View and Access Account Information

A PC 600 (FIG. 11) can use either mobile device software 21 or terminal software 23, or both the mobile and terminal versions, to view account information 900 on the display 1343, screen, or monitor of PC 600. For example, PC 600 may receive information from server 100 through web server 500 via the server to web server transmission routine 1530 and web page transmission routine 1516 if PC 600 is receiving the type of information a terminal 700 would ordinarily receive. As discussed above with reference to FIG. 1, a terminal 700 and a PC 600 may have the same hardware and be connected to the same type of network structure. However, a terminal 700 refers to a computer in a public or semi-public location such as a library computer, school computer, kiosk, workstation, or Internet cafe computer. PC 600 could receive information from the server's output routine 1180 if PC 600 is running mobile device software 21. Some adaptations of mobile device software 21 may need to be effected to make sure mobile device software 21 can run on a PC 600. The registration routine 2300 may be programmed to allow a user 30 to select a computer or laptop during the registration routine 2300. The URL transmission routine 631 would locate the URL 630 of server 100 (or a generic file server, web server, or ftp server) which would direct user 30 to the appropriate installation package 640 for his or her PC 600, mobile device 300, or terminal 700. User 30 can download and install the package using the installation routine 3100.

PC 600 also presents an option to implement another way to transfer and store the account information 900 (though certain types of mobile devices 300 can implement this feature as well). In this method, a secure connection and a username and password are used to transfer the account information 900, and server 100 may associate the username and password with a particular set of account information 900. The account information 900 may be sent through a secure technology to PC 600 using technologies such as SSL, Transport Layer Security (TLS), digital certificates, or technology adhering to the X.509 standard for a public key infrastructure (PKI) for single sign-on (SSO) and Privilege Management Infrastructure (PMI). When a user 30 registers his or her computer 750 with server 100, server 100 will associate a subset of the account information 900 with the user's identification information 901. When user 30 requests an account information update, the PC sends the username and password to server 100. Server 100, which then retrieves the corresponding information, using the selection routine 1150 (See FIG. 11), will then send the account information 900 to PC 600. To enhance security, SSL or technologies can be used for communications between PC 600 and server 100. To prevent others from accessing unencrypted information on PC 600, PC 600 may encrypt the information once it is received by PC 600, using the encryption routine 1130 (See FIG. 11). Similarly, server 100 may also store its information in an encrypted format as well.

A major drawback of this method is that the method is only as secure as current web security protocols such as SSL allow (moreover, complicated web security programs are often not compatible with the limited processing power of mobile devices). Combined with the limited functionality now in place in most web browsers of mobile devices 300, use of this method on a mobile device 300 with limited security and processing power (an older cellular phone, for example) may be less desirable than use of this method on a PC 600. Most currently available PCs 600 have the processing power to easily implement this method. The previously described system 10 avoids having to rely on SSL or other secure transfer technologies by sending the information encrypted from server 100 using a powerful encryption schema such as the Advanced Encryption Standard (AES) compliant with U.S. Federal Information Processing Standard PUB 197 (FIPS 197) issued by the National Institute of Standards and Technology (NIST).

### Software Description

Referring to FIG. 2, mobile device software 21 installed on mobile device 300 can take the form of web software such as an applet, compiled software, or an ActiveX control. Mobile device software 21 can be built using application development software libraries such as Visual Basic, ASP.net, ColdFusion, or Adobe Flex. The same is true for PC software 22 installed on PC 600, and terminal software 23.

A chief difference between mobile device software 21 executed by mobile device 300 and terminal software 23 (FIG. 2) executed by terminal 700 is that mobile device software 21 is designed not to require a currently active Internet connection. Indeed, mobile device software 21 on mobile device 300 is designed to save a user's information by downloading updates to the mobile device database 320 in memory 310 (FIG. 1), while mobile device 300 has a network connection. Mobile device 300 displays the most recently downloaded version of the database 320 when user 30 does not have a network connection. The ability to have rollback or multiple versions of the mobile database is also contemplated. One of the objects of the present invention is to provide mobile device software 21 for a mobile device 300 that will allow a user 30 to view account information 900 even when user 30 does not have an active Internet connection. On the other hand, a user 30 who is accessing information from a terminal 700 will likely have an active network connection, so providing software that can store the information for viewing offline may be less important. For a terminal 700, the need to maintain user security will likely be paramount to that of offline data storage, so in many embodiments, when the connection to web server 500 is terminated, the account information 900 will be erased or deleted from the memory of terminal 700.

### Special Software Features

In addition to the various features and embodiments described above, configurations of the present invention may also utilize a special access password routine 4000 (FIG. 8) or a privileged access routine 4200 (FIG. 9). The software 20 installed on client 650 may have either of these features enabled (650′ denotes a second user's client). For example, in a graphical user interface 1000 the special access password routine 4000 and the privileged access routine 4200 may have buttons 4100′ and 4200′ that exist on two separate screens or may be displayed one after the other as depicted in FIG. 8. The special access password 4100 will give a second user the ability to view and or modify a user's account. Special access passwords 4100 may expire after the second user has logged into the first user's account a predetermined number of times. Special access passwords 4100 may also be set expire after a predetermined amount of times. In one embodiment of the present invention, the second user is limited to a single logon and special access password 4100 expires after 24 hours, whether it has been used by the second user or not. A privileged access routine 4200 provides a second user with the ability to view and or modify the first user's account, but the privileged access routine 4200 remains in force until the first user (or an administrator) terminates or changes the second user's access.

To implement a special access password routine 4000, the client software 20 can display an appropriate graphical user interface 1000 to allow user 30 to access the feature. For example, client software 20 may display a webform 520, wherein user 30 will enter at least some of the identification information 901 of a second user, via the identification information entering step 905 (see FIG. 17H). Alternatively, a web page 515 may allow a user 30 to select a second user from a list of other users. The first user may also set the number of times the special access password 4100 will work as well as an expiration date. For example, a special access password 4100 could expire after one, two or ten uses. Similarly, a special access password 4100 could expire after 30 minutes, 24 hours, 4 days, or one year. According to an embodiment of the invention, a first user may be allowed to search for other users. Once the identification information 901 is entered, the first user will click a “send” or “OK” button 1010, which will send (using a special access request routine 4030) the information from client 650 to server 100. Server 100 would generate a special access password 4100 (via the special access password generation routine 4010) and then send the special access password 4100 to the second user, either by a communication like email, fax, Short Message Service (SMS) message, etc or by providing a notice in the second user's graphical user interface 1000 (using a special access password transmission routine 4020). The notice may take form of a message, a new icon, or other mechanism for notifying the second user that he or she may now access the first user's information. The notice or communication may also tell the second user the number of times he or she can use password 4100, and it may also tell the second user the expiration date of password 4100.

To implement a privileged access routine 4200 (FIG. 9) the client software 20 will display an appropriate graphical user interface 1000 (the second graphical user interface is designated 1000′) to allow the first user to access the feature. For example, the graphical user interface 1000 may display a webform 520, wherein the first user will enter at least some of the identification information 901 of a second user. The first user may set an access level 4210 of the second user through predefined rights or by customizing access. For example, a first user may allow a second user to view all health information within the last year, but limit modifications to the last two months. Other embodiments of the invention may allow a first user to search for other users. Once the information is entered, the first user may click a “send” or “OK” button 1010, which invokes a client to server privileged access transmission routine 4220, which transfers the information from client 650 to server 100. Server 100 may then send a communication or a notice (via a server to client privileged access transmission routine 4230) to the second client 650′. Client software 20 running on the second's client may display a window 1020 having an option 4240 that will allow the second user to view or modify account information 900 of the first user's account. Similarly, the first user's graphical user interface 1000 may display a window 1020 which reveals the account information 900 of the users that the first user has been authorized to view. By viewing an alternate window 1020 (or in some embodiments clicking on appropriately labeled link or button), the first user can view or modify the information of the other user. In addition, this graphical user interface 1000 may show the identification information 901 of the users that the first user has allowed to access his or her account (shown as 901 in FIG. 9). The first user may be able to see certain identification information of the other user, and by clicking on a button or hyperlink 1030, the first user may have the ability to revoke or alter the access privileges other users.

In many of these systems, confidentiality and controlled access to the various users' account information will be important to the users or the providers of the account information. Use of the various encryption systems described herein can improve security of the account information without making interaction with the software unnecessarily complicated.

### System for Provisioning and Validating Mobile Device Software

FIG. 12 depicts system 1200 that facilitates provisioning mobile device software 21 and registering mobile device 300 with server 100. FIG. 12 is described with continued reference to the embodiments illustrated in FIGS. 1-11. However, FIG. 12 is not limited to those embodiments. External data source 1202 may be external to feed source 200 as depicted in FIG. 12. In accordance with an embodiment of the present invention not shown in FIG. 12, external data source 1202 may be resident on feed source 200. Feed source 200 facilitates secure data upload 1204 to server 100. In an embodiment, external data source 1202 may be a health information provider such as HealthAtoZ, Express Scripts®, or PHR-Lite®. Data may be entered into external data source 1202 via a PHR vendor's interface (not shown).

According to an embodiment of the present invention, PHR and claims data is transferred from feed source 200 to server 100 through secure upload 1204. In an embodiment, secure upload 1204 can be performed in batch mode (i.e., daily, hourly, or at another tunable interval). Alternatively, secure upload 1204 can occur periodically or on an ad-hoc basis (i.e., as data is entered into external data source 1202). Secure upload 1204 is accomplished through use of feed source software 24 and administrative messaging applications. In accordance with an embodiment, feed source software 24 and administrative applications discard unneeded data so that a subset data from external data source 1202 is transferred to server 100.

In an embodiment of the invention, during secure upload 1204, a subset of the data from external data source 1202 is used to populate vault database 1222 on server 100. In the example embodiment depicted in FIG. 12, server 100 has vault application 1206 resident on it. As a result of completing secure upload 1204, vault application 1206 comprising a secure data store is populated on server 100. Although FIG. 12 only depicts a single external data source 1202, vault database 1222 may contain data from multiple external data sources 1202. The data stored within vault database 1222 accessed by vault application 1206 may pertain to multiple users 30. A local, persistent, secure data store (server-side digital wallet 1223) may be created on server 100 to store account data for a given user 30. In an embodiment, server-side digital wallet 1223 may utilize server database 150 of server 100 (FIG. 1). Software commercially available from companies such as Diversinet Corporation of Toronto, Canada may be used to provide the server-side wallet functionality.

In order to access data in vault database 1222, a user 30 of mobile device 300 registers via web portal 1232 on web server 500. According to an embodiment, registration is performed via network connection 1214 to web portal 1232. Network connection 1214 may be an Internet connection to web server 500. In an embodiment, user 30 registers for mobile data delivery service to mobile device 300 by entering their mobile phone number. An activation key is then displayed for user 30 in web portal 1232. In an embodiment, the activation key may be displayed in a web portal such as the exemplary web portal depicted in FIG. 17A by clicking on the hyperlink 1730. User 30 is able to retrieve the activation key via network connection 1214 to web server 500. This activation key may be entered by user 30 in order to download mobile device software 21 from provisioning server 1230. This provisioning process is described in more detail in the following paragraphs.

After obtaining the activation key from web portal 1232, user 30 is then sent an SMS message which is routed to mobile device 300 based upon the provided mobile phone number. This SMS message is sent via network connection 1214 and contains a secure link to download mobile device software 21. During the provisioning process, device-type information from mobile device 300 is used to determine the appropriate version of mobile device software 21 to be downloaded via connection 1216. Connection 1216 may be used to connect to the provisioning server 1230 based upon the address referenced in URL 630. Server 100 may transmit a URL 630 to mobile device 300 via connection 1208 using a URL transmission routine 631. In the exemplary embodiment depicted in FIG. 12, URL 630 is the address of provisioning server 1230. In the embodiment of FIG. 12, provisioning server 1230 hosts installation package 640 for the mobile device software 21. As described above with reference to FIG. 11, in alternative embodiments, installation package may be hosted by server 100 or web server 500. Information about the specifics of mobile device 300 is automatically determined by provisioning server 1230. In an embodiment, information about the specifics of mobile device 300 is determined by examining the user agent string. According to this embodiment, when the secure link is activated by user 30, provisioning server 1230 uses a user agent string associated with mobile device 300 to determine the correct version of mobile application software 1212 to send to mobile device 300 via connection 1216. The user agent string (not shown) is sent via connection 1216 to provisioning server 1230. The user agent string identifies the Internet browser installed on mobile device 300 and provides certain system details to provisioning server 1230. Information in the user agent string identifies characteristics of mobile device 300 such as manufacturer, model, processing capabilities, and installed software. The version of mobile device software 21 selected for mobile device 300 is based on the device's characteristics and capabilities (e.g., the manufacturer, model, processing capability, memory, and storage capacity). Mobile device software 21 is then sent to mobile device 300 to be installed. According to an embodiment of the invention, mobile device software 21 includes a Java applet received from provisioning server 1230.

Once installed on mobile device 300, mobile device software 21 is then launched by user 30 so that it can be activated. Activation is accomplished by user 30 entering the activation key provided by web portal 1232 via network connection 1214. The activation key is a one-time code for permission to download a soft token (i.e., a seed value). During activation, a seed value is created and a local secure data store (i.e., an encrypted data storage area) is created on the mobile device where the seed is stored. The seed value is assigned to the user of the mobile device and is stored in an encrypted data store on the mobile device.

Mobile device software 21 accesses a local, persistent, secure, data store (mobile digital wallet 1224) that contains uploaded data from external data source 1202 (via vault application 1206 on server 100). Data within mobile digital wallet 1224 can be accessed by mobile device software 21 on mobile device 300. The data stored in mobile digital wallet 1224 pertains to a user 30 associated with mobile device 300. In an embodiment, mobile digital wallet 1224 may utilize mobile device database 320 (FIG. 1). Mobile digital wallet 1224 may be encrypted to protect data stored within the wallet. Software commercially available from companies such as Diversinet Corporation of Toronto, Canada may be used to provide the mobile digital wallet functionality.

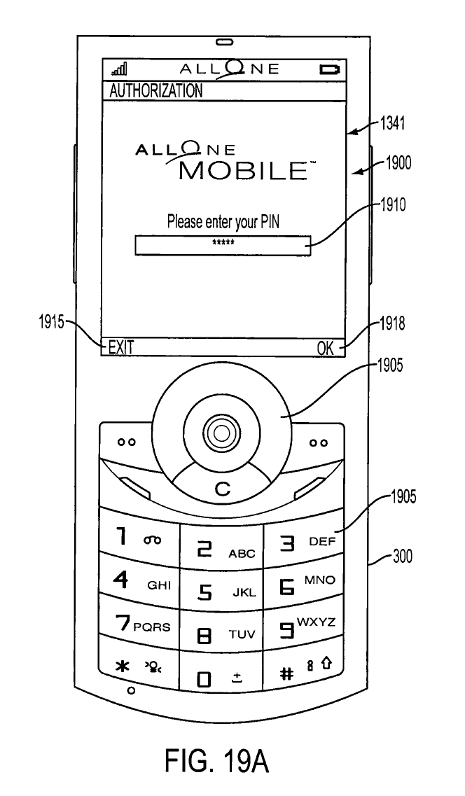

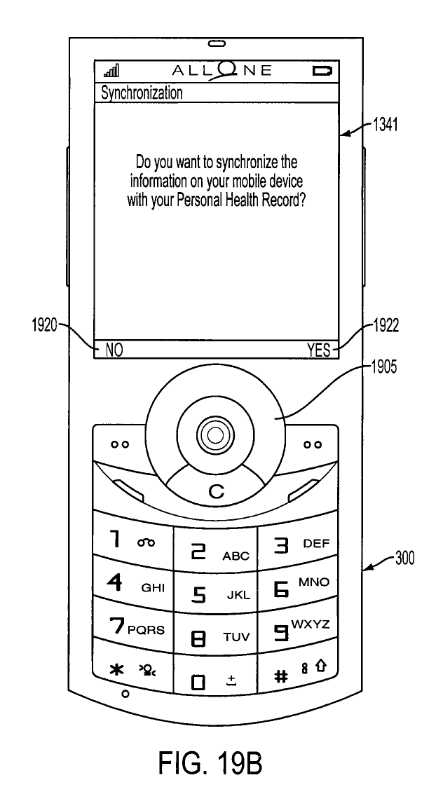

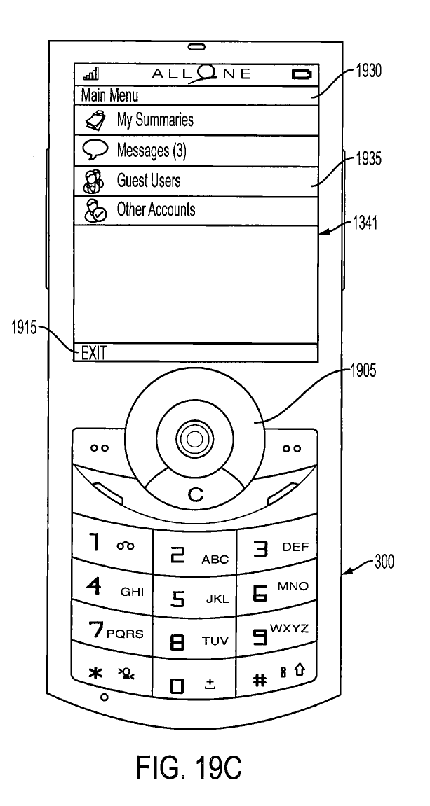

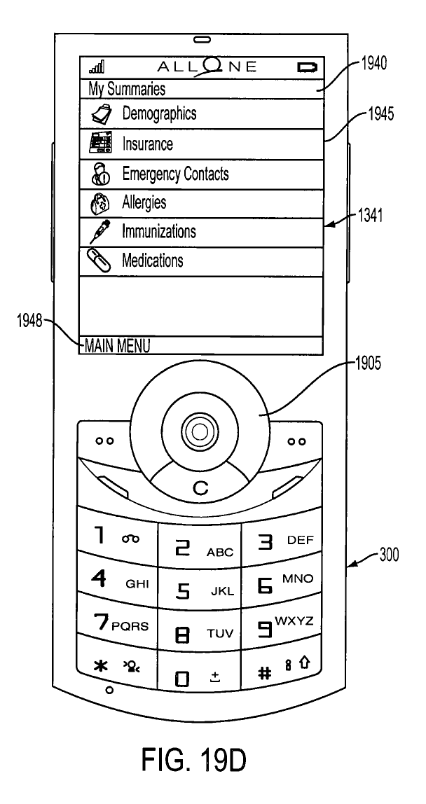

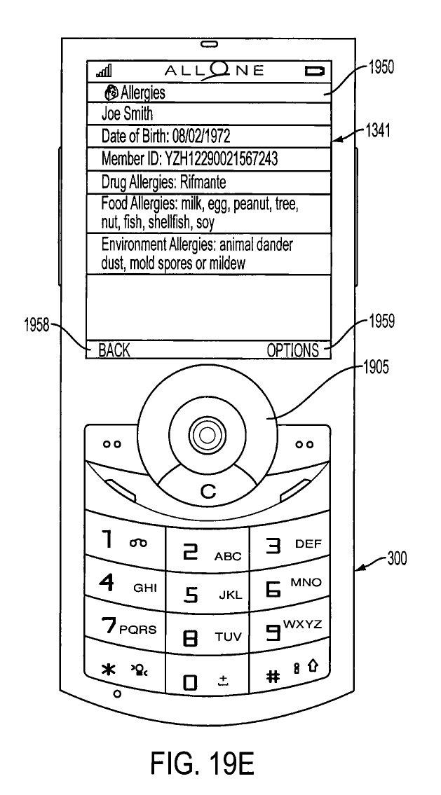

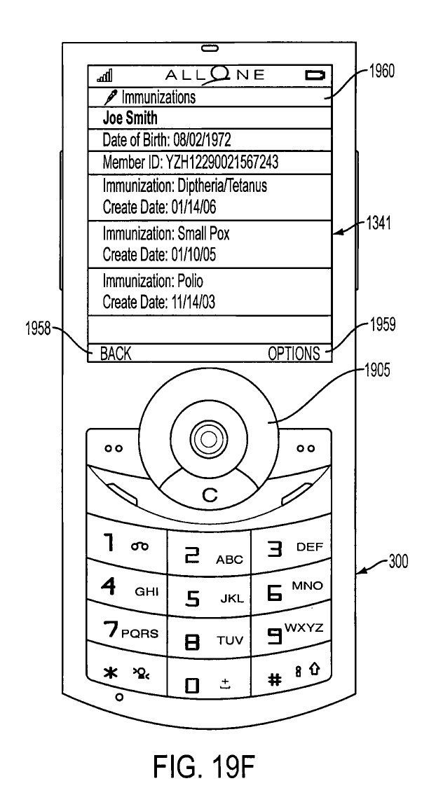

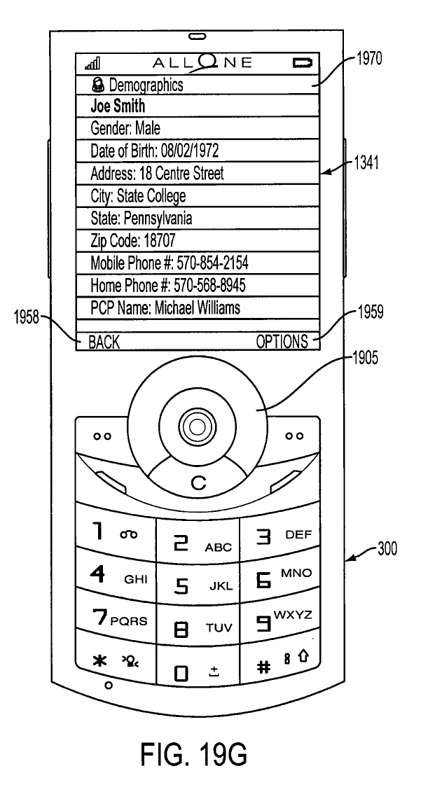

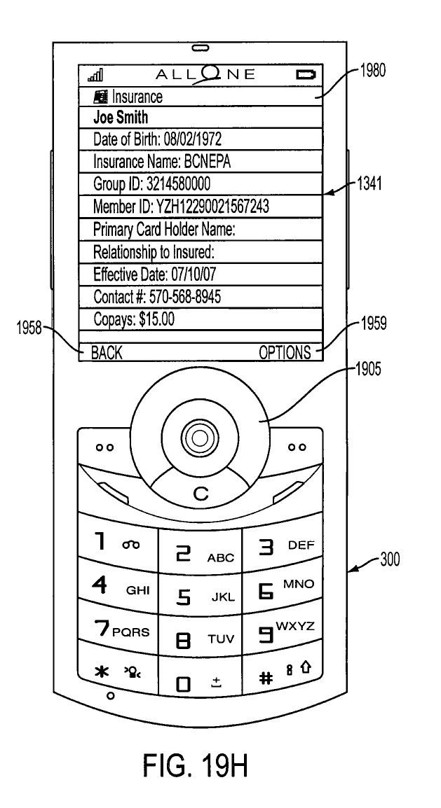

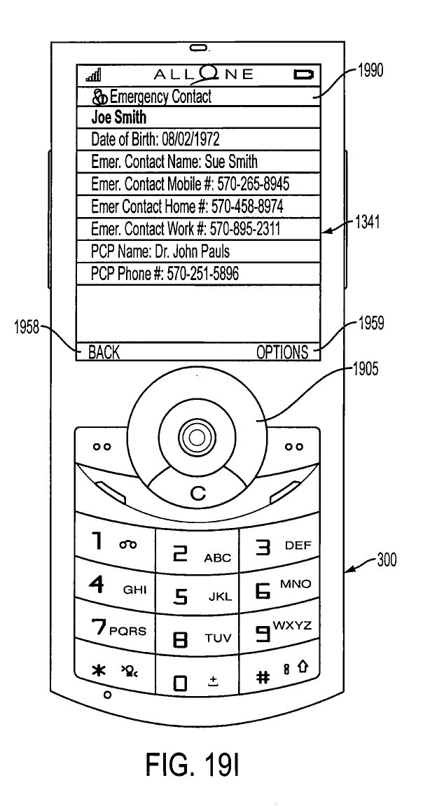

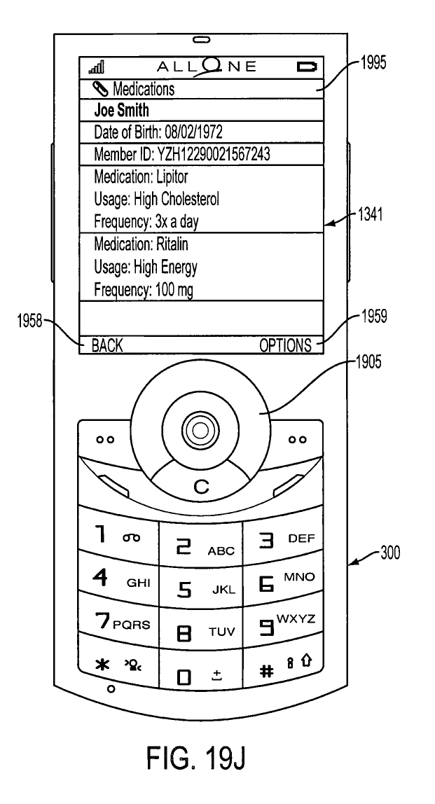

Next user 30 is validated against provisioning server 1230. In an embodiment, validation may consist of verifying account information pertaining to user 30. Alternatively, validation may consist of verifying information about mobile device 300 associated with user 30. Once validated, user 30 is asked to choose and enter a personal identification number (PIN) number that will be used as a security code to be able to launch and use the mobile device software 21. An exemplary graphical user interface for a user 30 to enter a PIN using mobile device software 21 is illustrated in FIG. 19A.

In an embodiment of the present invention, the version of mobile device software 21 is then checked when the software is launched in order to determine if a newer version exists. If it is determined that a newer version of mobile device software 21 exists, then an update is performed. The update process consists of provisioning server 1230 sending or ‘pushing’ a new version of mobile device software 21 to mobile device 300 via connection 1216.

If a data synchronization or fetch request is made in mobile device software 21, user 30 is authenticated by validation application 1234. An exemplary interface for making a synchronization request with mobile device software 21 is depicted in FIG. 19B. In the embodiment depicted in FIG. 12, validation application 1234 is resident on server 100. In an alternative embodiment, validation application 1234 may reside on a separate validation server (not shown).

According to an embodiment, the authentication process uses a One Time Password (OTP) that is generated by mobile device software 21 using a mathematical algorithm. The mathematical algorithm uses a seed value, which is stored within the data store, and a counter to generate the OTP. The OTP is used once and changes with each login by user 30. The generated OTP is not editable or accessible to user 30 of mobile device 300 and is not stored on either mobile device 300 or server 100. In an embodiment, an Initiative for Open Authentication (OATH) standard specified complex pseudo-random algorithm may be employed to generate the seed value.

In an embodiment, data synchronization and fetch requests sent between mobile device 300 and server 100 via connection 1208 are authenticated by validation application 1234 using two-factor authentication. In system 1200, two factor authentication is performed by authenticating something the user has (e.g., the seed value stored on mobile device 300) and something the user knows (e.g., the user-selected PIN). In system 1200, a series of one-time passwords are generated by the mathematical algorithm from the encrypted seed value. In this way, each OTP cannot be guessed or predicted, even if a previously used OTP is known. User 30 of mobile device 300 cannot access or edit the seed, seed identifier, counter, or the generated OTP. In accordance with an embodiment, the mathematical algorithm does not use any unique hardware identifiers or characteristics from mobile device 300 to generate the OTP. The seed value may be stored in an encrypted database on server 100. During authentication, the OTP generated on mobile device 300 is sent to server 100 along with a seed identifier corresponding to the seed value used to generate the OTP. The seed identifier is a unique number that is used to retrieve the seed from the encrypted database (not shown) on server 100.

Once authentication is successfully completed by the validation application 1234, data is sent encrypted to mobile device 300 via connection 1208. In accordance with an embodiment of the present invention, connection 1208 comprises a closed-end pipe connection between server 100 and mobile device 300. In an embodiment, the closed-end pipe connection may comprise a Secure Sockets Layer (SSL) connection. Connection 1208 may also use the Transport Layer Security (TLS) cryptographic protocol. Data in vault database 1222 is then transmitted to and stored on mobile device 300 in the secure data store on mobile device 300. Account data for user 30 now resides both on the user's registered mobile device 300 and in vault database 1222 on server 100. A security advantage of this embodiment is that no other unregistered mobile device can be used by user 30 to access data, thus ensuring that account data is secure even if user 30 attempts to access the data from an unregistered mobile device.

### Method for Provisioning and Updating Mobile Device Software

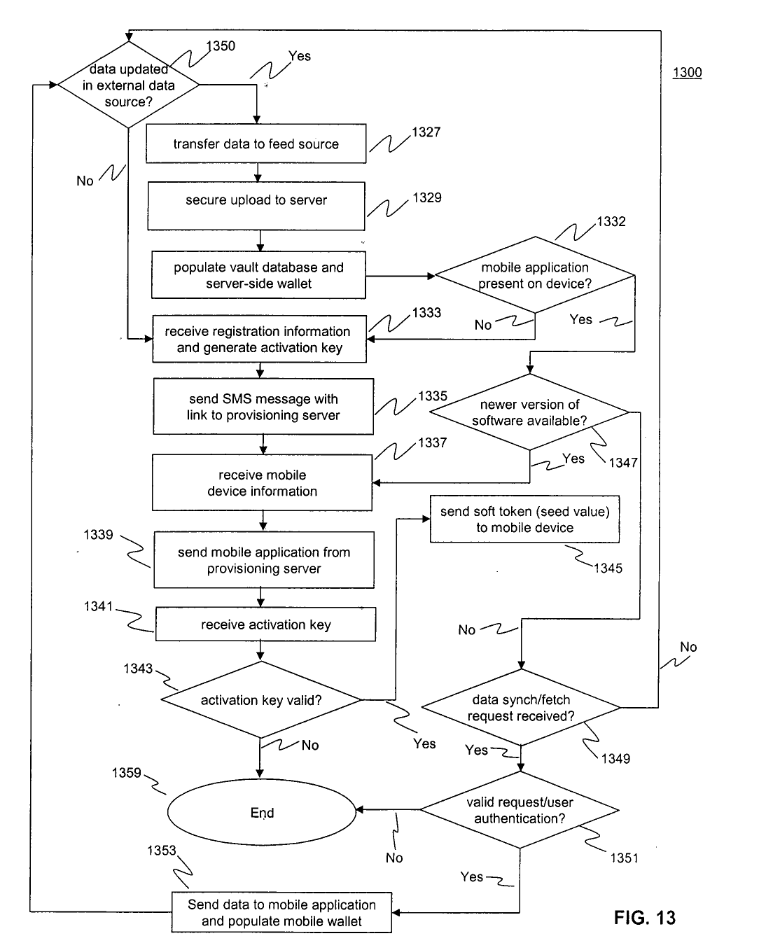

FIG. 13 is a flowchart 1300 illustrating steps by which data and software is sent from a server to a mobile device, in accordance with an embodiment of the present invention.

More particularly, flowchart 1300 illustrates the steps by which the method for installing software on a mobile device, including registration of a mobile device, user validation, and updating software on a previously-registered mobile device is performed, according to an embodiment of the present invention. Flowchart 1300 also illustrates the steps by which data is sent from an external data source to a server and subsequently transferred to a mobile device.

FIG. 13 is described with continued reference to the embodiments illustrated in FIGS. 1-12. However, FIG. 13 is not limited to those embodiments.

The provisioning method provisions mobile device software from a source system to a target client. The method also handles cases where a new, updated version of mobile device software is to be installed on a target client. In an embodiment, mobile device software is mobile device software 21 described above. Once installed by the provisioning method, the mobile device software synchronizes account data between a data vault and the target client. In this way, the provisioning method also synchronizes account data between a source system and a target client. According to an embodiment of the present invention, the target client is a mobile device such as mobile device 300 and the source system is a server such as provisioning server 1230. Note that the steps in flowchart 1300 do not necessarily have to occur in the order shown.

The method begins at step 1350 where an evaluation is made regarding whether a new data object has been created or account data has been updated in an external data source. In an embodiment, the external data source is external data source 1202 described above with reference to FIG. 12. If it is determined that a new data object has been created or data has been updated in an external data source, control is passed to step 1327. If it is determined that no new data object has been created and no new data has been updated in an external data source, then control is passed to step 1333.

In step 1327, data from the external data source is transferred to a feed source. In an embodiment, the feed source may be feed source 200 described above. In an embodiment, the creation of a new data object or a data update in the external data source triggers a data transfer to the feed source. In alternative embodiments, this step is performed periodically (i.e., hourly, daily, etc. in batch mode). After data is transferred from the external data source to the feed source, control is passed to step 1329.

In step 1329, data from the feed source is uploaded to a server. In an embodiment, this step comprises a secure upload to a server such as server 100 described above. This step may be accomplished through use of feed source 200 and administrative messaging applications. As described above, data feed applications and administrative applications may discard unneeded data so that a subset of account data is transferred to feed source 200. After data is uploaded to the server, control is passed to step 1331.

In step 1331, a vault database comprising a secure data store is populated on a server. In an embodiment, the vault database may be vault database 1222 described above. The vault database may contain data from multiple external data sources and the data stored within the vault database may pertain to multiple users 30. In this step, server-side digital wallet 1223 is also populated with account data for a specific user 30. In accordance with an embodiment, server-side digital wallet 1223 is a local, persistent, secure data store populated with a subset of data from vault database 1222 pertaining to a specific user 30. After the vault database and server-side wallet are populated, control is passed to step 1332.

In step 1332, a determination is made regarding whether the mobile application is present (i.e., installed) on the mobile device. If it is determined that the mobile application is already installed, control is passed to step 1347. Step 1347 is described in detail below. If it is determined that the mobile application has not been previously installed on the mobile device, control is passed to step 1333.

In step 1333, when a user registers for mobile account data delivery service by entering his/her mobile phone number, an activation key is generated. Registration may be performed via the Internet using the user's web portal and an activation key is then displayed for the user in a web portal accessible by the user. This activation key displayed in this step will be entered by the user later in the method as part of the provisioning in step 1339 below.

In step 1335, an SMS message is addressed to the mobile phone number received in step 1333. This SMS message contains a secure link to download a mobile application. In an embodiment, the mobile application is mobile device software 21 discussed above. The mobile application may include software that allows the user of the mobile device to view his/her account data, fax his/her data elsewhere, and synchronize account data stored in the vault to data stored in a local, persistent, secure data store on the user's mobile device.

In step 1337, when the link obtained in step 1335 is activated by the user information about the mobile device is received at a provisioning server. In this step, the provisioning server uses the mobile device's user agent string to determine the correct mobile application software version to send to the mobile device. In an embodiment, a user agent string identifying the mobile device's browser and providing certain system details is sent to the provisioning server in this step. The version of the mobile application selected for the mobile device in step 1339 is based on the mobile device's characteristics (i.e., manufacturer and model) and capabilities (i.e., processing capability, memory, and storage capacity).

In step 1339, the correct mobile application software version is sent to the user's mobile device to be installed. In an embodiment, the mobile application includes a Java applet received from the provisioning server. During this step, device-type information received from the mobile device in step 1337 is used to determine the appropriate mobile application to be sent. Information about the specifics of the mobile device may be automatically determined by the provisioning server in this step.

In step 1341, once the mobile application is launched, an activation key is received. In this step, the activation key may be received from validation application 1234. The validation application 1234 may be implemented on provisioning server 1230. The validation application 1234 may also be implemented on the vault server. The validation application 1234 may also be hosted on a separate, dedicated validation server (not shown).

In step 1343, an evaluation is made regarding whether the activation key is valid. If it is determined that the activation key matches the activation generated in step 1333, control is passed to step 1345. If it is determined that the activation key does not match, then control is passed to step 1359, where the process ends.

In step 1345, a soft token (i.e., a seed value) is sent to the mobile device. Upon receipt of the soft token, a seed value is created on the mobile device and a local secure data store (i.e., an encrypted data storage area) is created on the mobile device where the seed is stored.

In step 1347, an evaluation is made regarding whether a newer version of the mobile application is available from the provisioning server. If it is determined that a newer version of the mobile application is available, control is passed to back to step 1337. If it is determined that no newer version of the mobile application is available, then control is passed to step 1349.

In step 1349, an evaluation is made regarding whether a data synchronization or fetch request has been received from the mobile application. In another embodiment of the present invention, the receipt of a data synchronization or data fetch request may be detected in step 1350 by a listener running on server 100. If it is determined that a data synchronization or fetch request has been received, control is passed to step 1351 where the user is authenticated. If it is determined that no data synchronization or fetch request has been received, then control is passed to step 1350.

In step 1351, an evaluation is made regarding whether the user associated with the data synchronization or fetch request detected in step 1349 is valid. Validation is performed by performing an authentication procedure for the user associated with the data synchronization or fetch request. According to an embodiment, step 1351 may be performed by a validation application, such as validation application 1234. This step may be performed using an authentication process which validates a One Time Password (OTP) received with the request. Step 1351 may authenticate data synchronization and fetch requests through use of two-factor authentication. If it is determined that the data synchronization or fetch request is valid, control is passed to step 1353. If it is determined that the data synchronization or fetch request is not valid, control is passed to step 1359 where the process ends.

In step 1353, the requested data is sent in encrypted form to a mobile device associated with the requesting user through a closed-end (e.g., SSL) pipe connection between the vault database and the mobile device. In an embodiment, data in the vault database 1222 is transmitted to and stored on mobile device 300 in encrypted mobile digital wallet 1224. After this step is completed, the requested data resides both on the mobile device and in the vault database. After the data has been sent to the mobile device, control is passed to back to step 1350.

### Method for Providing Account Data to Emergency Personnel

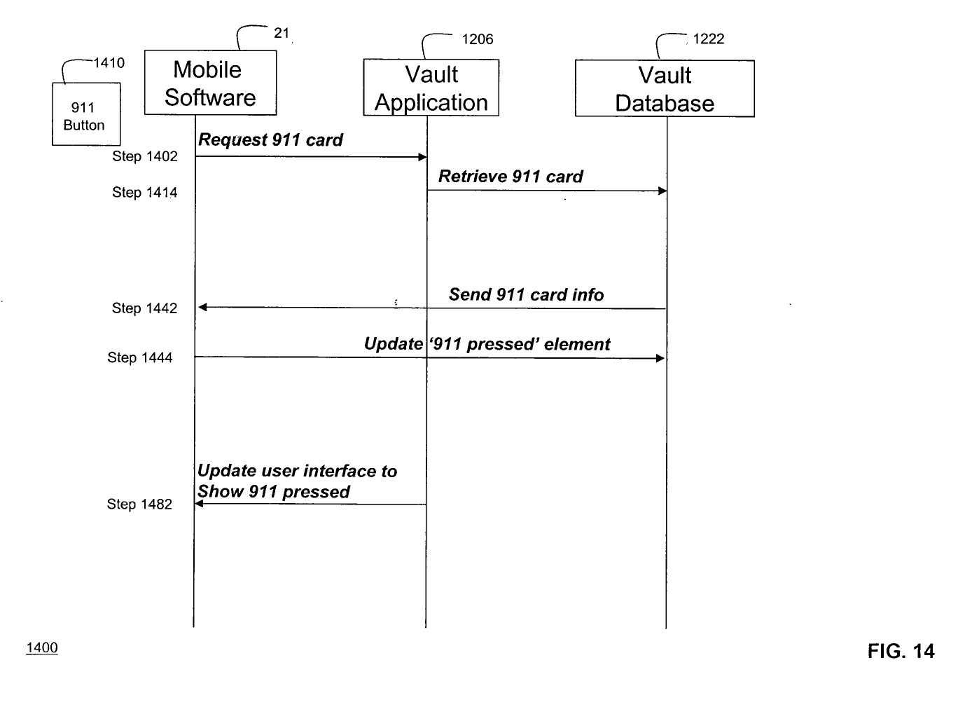

FIG. 14 provides a method 1400 for enabling an emergency responder to see emergency information on mobile device 300. FIG. 14 is described with continued reference to the embodiments illustrated in FIGS. 1-12. However, FIG. 14 is not limited to those embodiments. An emergency responder such as a paramedic, physician, or other first responder will not have access to the authentication information, such as a PIN, that user 30 possesses. The data on a digital 911 ‘card’ (i.e., a database record or data file) associated with user 30 is first marked by user 30. In an embodiment, a user wishing to use the 911 ‘break the glass’ functionality will mark data that he/she wants to designate as emergency data to subsequently be presented to an emergency responder.

In emergency situations where user 30 is unconscious or otherwise unable to use mobile device software 21, an embodiment of the present invention enables an emergency responder to display vital emergency information pertaining to user 30 on mobile device 300. Emergency information previously marked by user 30 may include, but is not limited to, the blood type for user 30, emergency contacts for user 30, medical insurance information for user 30, current medications being taken by user 30, and/or drug allergies for user 30. Method 1400 begins in step 1402.

In step 1402, an emergency responder selects a 911 icon 1310 displayed by mobile device software 21 on mobile device 300. In an embodiment, a 911 icon 1410 is displayed on the main screen of mobile device software 21. Icon 1410 is displayed in a screen before user 30 inputs a PIN number, thus allowing an emergency responder to select icon 1410 without furnishing a PIN number. After icon 1410 is pressed, an audit trail is created containing items such as date and time icon 1410 was pressed. In this step, a 911 card is requested by mobile device software 21. The request is sent from mobile device 300 to vault application 1206 on server 100.

At the opening screen displayed by mobile device software 21, the emergency responder can click on the 911 icon 1410 that figuratively “breaks the glass” allowing display of data on mobile device 300. Once chosen, the emergency data will then be displayed to the first responder by completing the steps described in the following paragraphs.

In step 1414, a 911 card is retrieved from vault database 1222.

In step 1442, the 911 card information is sent from vault database 1222 to mobile device software 21 on mobile device 300. In this step, the 911 card information is displayed by mobile device software 21 on mobile device 300. In this way, an emergency responder can see emergency information on mobile device 300 without compromising the security of account data associated with user 30.

In step, 1444, the ‘911 pressed’ element is updated in vault database 1222.

In step 1482, after the ‘911 pressed’ element is updated, the next time user 30 launches mobile device software 21, icon 1410 will show a “cracked” appearance thus visually notifying the user that someone has accessed his/her emergency record. In an embodiment, the virtual glass can be ‘fixed’ when user 30 logs into web server 500 and resets the ‘911 pressed’ element (step not shown).

Method for Question/Response Messaging between a Mobile Device and a Server

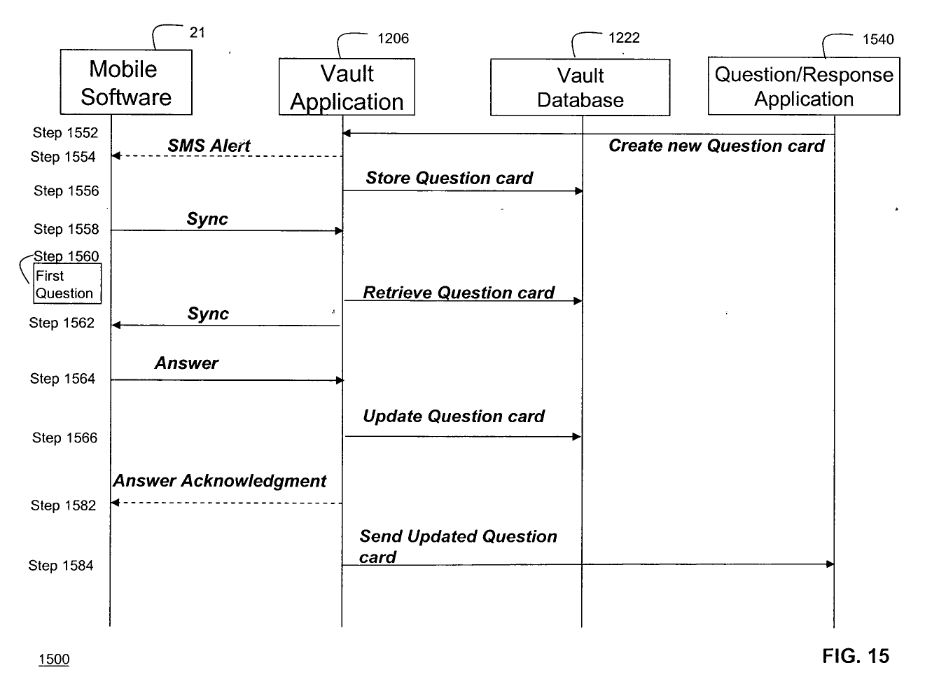

FIG. 15 illustrates a method 1500 for exchanging question/response messaging between mobile device 300 and server 100, in accordance with an embodiment of the present invention. FIG. 15 is described with continued reference to the embodiments illustrated in FIGS. 1-12. However, FIG. 15 is not limited to those embodiments.

Question/Response messaging method 1500 supplements the delivery of account information 900 to mobile device 300 by enabling bi-directional communications via an exchange of electronic question ‘cards’ and corresponding responses between server 100 and mobile device 300. The question cards comprise a data message which is forwarded to users 30 of mobile devices 300 fitting a certain user profile. Users 30 are able to retrieve the question cards during the synchronization process 1300 described above. In an embodiment, question cards are displayed using mobile device software 21. Users 30 can then enter a response to the question indicated on the question card using the interface of mobile device software 21 running on mobile device 300.

Question/Response Messaging method 1500 utilizes question/response application 1540 to create personalized sets of information regarding a user 30 of mobile device 300. Wording of questions in question cards created with question/response application 1540 may be edited by an administrator using an administrator interface on server 100. Once created, question cards are saved on a server (such as server 100 or web server 500). Users 30 of mobile devices 300 who are subjects of the questions on newly-created question/response cards then receive SMS ‘alert’ messages prompting them to retrieve the question card. Question cards are sent to a mobile device 300 associated with a user 30 during the next synchronization between mobile device 300 and server 100. Question cards are fetched from a server to mobile device 300. Responses are automatically sent from mobile device 21 back to server 100 during a subsequent synchronization. In an embodiment, an administrator (i.e., for a health care provider such as a physician's office, clinic, pharmacy, hospital, hospice, or assisted living facility) can monitor user's responses via an administrator interface and refer back to saved responses in the future. Responses may be collected on server 100 and saved in vault database 1222.

Method 1500 begins in step 1552.

In step 1552, a new question card is created by an administrator (or an administrator's agent) through input into question/response application 1540. In an embodiment, question/response application 1540 may be hosted on server 100 or web server 500. Once the question card is created, it is sent to vault application 1206.

In step 1554, an SMS alert message prompting the user to retrieve the question cards is sent to mobile device 300 and displayed by mobile device software 21.

In step 1556, the question card created in step 1552 is stored in vault database 1222. In an alternative embodiment, the question cards reside on web server 500 and are available to be edited and viewed by administrators at web site 510 (see FIG. 10). In this step, the question card is saved in vault database 1222 so that it can be scheduled for delivery to a user 30 or set of users 30 in the future.

In step 1558, a synchronization is requested by user 30 on mobile device 300 in response to the SMS alert received in step 1554. During step 1558, a synchronization occurs between mobile device software 21 on mobile device 300 and vault application 1206 on server 100. The synchronization in this step may be initiated using the user interface of mobile device software 21 (See FIG. 19.B).

In step 1560, the question card saved in step 1556 is retrieved from vault database 1222. The retrieval is based upon the mobile device software 21 that initiated the synchronization in step 1558. In this step, the question card is retrieved from vault database 1222 for subsequent delivery during a synchronization with mobile device software 21.

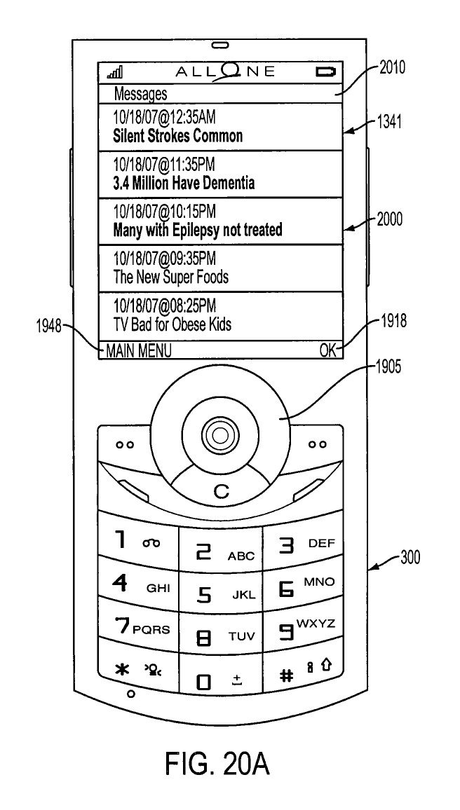

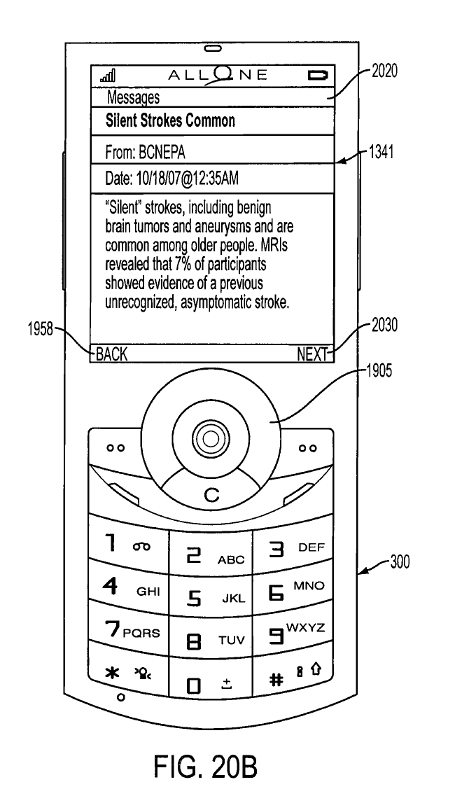

In step 1562, once scheduled for delivery, a message with the question card is then sent to mobile device 300 during synchronization with vault application 1206. When the synchronization is complete, the question card is stored on mobile device 300. The synchronization may be initiated by a user 30 of the mobile device using a user interface (See FIG. 19B). In an embodiment, the question card may be stored in mobile digital wallet 1224 or mobile device database 320. An exemplary interface for displaying messages on the mobile device is illustrated in FIGS. 20A and 20B.

In step 1564, once opened the question is answered by user 30 and that answer is then sent up to the vault application 1206 during data synchronization with vault application 1206.

In step 1566, the question card is updated in vault database 1222. In an embodiment, after the question card update, answers are subsequently displayed to authorized users in a “dashboard” like user interface (not shown).

In step 1582, an answer acknowledgement is sent to mobile device software 21 on mobile device 300.

In step 1584, an updated question card is sent from vault application 1206 to question/response application 1540.

Method for Exchanging Decision Trees between a Mobile Device and a Server

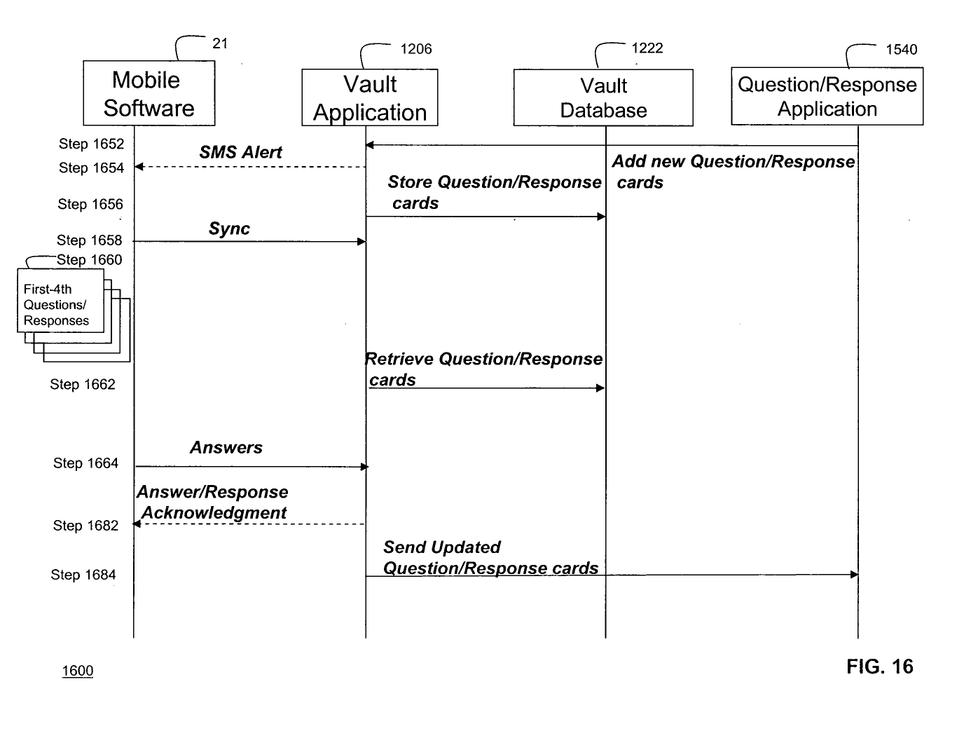

FIG. 16 provides a method 1600 for exchanging a series of questions and a decision tree of related answers between mobile device 300 and server 100, in accordance with an embodiment of the present invention. Method 1600 is implemented based upon the question/response method 1500 described above. Method 1600 allows user 30 to enter all questions and possible answers including what results are to be displayed when particular answers are received by mobile device software 21 on mobile device 300. Method 1600 can be used to exchange questions and responses between a mobile device and a server through a messaging system. Flowchart 1600 provides the steps by a decision tree comprising a series of questions and corresponding question/response exchanges are sent between a mobile device and a server. In an embodiment, subsequent questions in the decision tree are based on the range of potential answers to previously sent questions. The decision tree maps out the range of possible answers to one or more subsequent (i.e., follow-up) questions based on responses to prior questions in the decision tree.

FIG. 16 is described with continued reference to the embodiments illustrated in FIGS. 1-12 and 15. However, FIG. 16 is not limited to those embodiments. By performing the steps described below, user 30 will create process flow for desired questioning and processing corresponding responses.

Method 1600 begins in step 1652.

In step 1652, an administrator creates series of Question/Response cards using a user interface (See FIG. 17E) of question/response application 1540. As discussed above with reference to FIG. 15, question/response application 1540 may be hosted on server 100 or web server 500. In this step, one or more question/responses card are created by question/response application 1540 based upon administrator input. Once the question/response cards are added, they are sent to vault application 1206.

In step 1654, an SMS alert message is sent to mobile device 300 and displayed by mobile device software 21.

In step 1656, a question/response cards are stored in vault database 1222. In this step, an administrator (or the administrator's agent) schedules the release of the question/response cards to a population of other users. In an embodiment, the question/response cards comprise a series of related question/response cards.

In step 1658, a synchronization occurs between mobile device software 21 on mobile device 300 and vault application 1206 on server 100. In this step, once scheduled, an unpopulated decision tree is then downloaded to user 30's mobile device 300 through the synchronization.

In step 1660, an administrator populates the decision tree by inputting a series of questions and possible responses to the questions contained the decision tree. In this step, an administrator or agent of the administrator may create a series of questions and range of potential responses to the series of questions. In this step, the series of questions and range of responses are populated in the decision tree using a user interface (not shown). In step 1660, the administrator saves the questions/responses so they can be scheduled for delivery to a user 30 or set of users 30 in the future and the question/response cards are retrieved from vault database 1222.

In step 1662, once scheduled for delivery, a message with the question/response cards is then sent to mobile device 300 during synchronization with vault application 1206.

In step 1664, once opened, the question/response cards can be then be answered by user 30 and the corresponding answers sent to server 100 during data synchronization with vault application 1206. In this step, user 30 answers the questions and a decision tree is populated based upon the answers from user 30. The answers are stored for later transmission to vault application 1206. Depending on the answers and the design of the decision tree, some results may be displayed to user 30 via mobile device software 21. All answers will be transferred to server 100 at completion of population of the decision tree. Answers are subsequently displayed as messages to authorized users in a dashboard-like user interface (See message 1756 in FIG. 17E) in order to facilitate interpretation of the results.

In step 1682, an answer acknowledgement is sent to mobile device software 21 on mobile device 300.

In step 1684, updated question/response cards are sent from vault application 1206 to question/response application 1640.

### Message Deletion Embodiment

In an embodiment, selected messages associated with the methods illustrated in FIGS. 14-16 can be deleted from mobile device 300 by a user 30. User 30 may choose from an options menu within mobile device software 21 and choose the delete function for messages stored on the user's registered mobile device 300. Once this function is chosen, the corresponding message will be marked for deletion from mobile device 300. Once mobile device 300 is synchronized with server 100, the marked message will then be deleted from the local data store on mobile device 300. As discussed above with reference to FIGS. 1 and 12, mobile digital wallet 1224 on mobile device 300 may utilize mobile device database 320. In an alternative embodiment, user 30 may be granted privileges to delete messages from the local data store without a synchronization between mobile device 300 and server 100 occurring.

### Example Graphical User Interfaces

FIGS. 17A-I and 18A-G depict a graphical user interface (GUI) for displaying medical account information such as a PHR. In an embodiment of the invention, graphical user interface 1000 and graphical user interface 1000′ may include the exemplary interface illustrated in FIGS. 17A-I and 18A-G. FIGS. 17A-I and 18A-G are described with continued reference to the embodiments illustrated in FIGS. 1-12 and 14-16. However, FIGS. 17A-I and 18A-G are not limited to those embodiments. Throughout FIGS. 17A-I, displays are shown with various hyperlinks, command regions, tabs, buttons, checkboxes, and data entry fields, which are used to initiate action, invoke routines, enter data, view data, or invoke other functionality. For brevity, only the differences occurring within the figures, as compared to previous or subsequent ones of the figures, are described below.

FIGS. 17A-I illustrate an exemplary GUI 1700 for viewing claims information, guest accounts, other accounts, and messaging settings, in accordance with an embodiment of the invention. Web pages 515 generated by web server 500 via web page generation routine 1514 may comprise graphical user interface 1700 depicted in FIGS. 17A-I. In an embodiment, GUI 1700 may be displayed on display 1342 of PC 600 and/or display 1343 of terminal 700 (See FIG. 2).

FIG. 17A illustrates a top-level web page 515 that user 30 may access at PC 600, client 650, or terminal 700 in order to access his or her account information 900 (see FIG. 2). In the example embodiment depicted in FIGS. 17A-I, account information 900 pertains to health information.

In the example embodiment depicted in FIG. 17A, user 30, using an input device, may select one or more of hyperlinks 1710 to view his or her health data, send his or health data via facsimile, create a new one-time guest user, view other accounts (other than the one-time guest user), manage his or her mobile devices, and view messages. By selecting one of hyperlinks 1710, user 30 may view, print, and/or fax account summaries such as health summaries. User 30 may also select one of hyperlinks 1710 to view claims information, such as insurance claims. User 30 may also select one of hyperlinks 1710 to view claims information, such as insurance claims. User 30 may select hyperlink 1720 to contact customer support and may select hyperlink 1730 to review and change settings for a mobile device 300 associated with user 30. Selection of hyperlink 1730 may invoke another interface (not shown) which allows user 30 to register mobile device 300 via web portal 1232 on web server 500 as described above with reference to FIG. 12.

FIG. 17B depicts a claims information tab 1740. In an embodiment, user 30 may select claims information tab 1740 using an input device in order to display insurance claims that have been sent to system 10. In the example embodiment depicted in FIG. 17B, the claim information may include health insurance claims such as, but not limited to pharmacy-related claims.

FIG. 17C depicts a messaging tab 1750. In an embodiment, an administrator may select messaging tab 1750 within interface 1700 using an input device in order to create messages to be sent by system 10. In the example embodiment depicted in FIG. 17B, an administrator may select hyperlink 1751 to enter message information including a message title 1752, header 1754, and message text 1756. The message may be previewed in message preview pane 1758. Once message information has been entered by an administrator, it may be assigned to a user 30 or multiple users 30 by selecting hyperlink 1753 and subsequently sent by selecting submit button 1759. Selection of hyperlink 1753 causes the interface illustrated in FIG. 17E to be displayed. This interface is described below with reference to FIG. 17E.

FIGS. 17D-F depict user interfaces for displaying and managing messages. FIG. 17D depicts messages tab 1760 used to display messages and notices sent to user 30. In the example embodiment depicted in FIG. 17D, the messages are sent to user 30 by a health care provider, but the messages may be sent by other entities such as businesses, employers, and/or government organizations.

FIG. 17E depicts an exemplary interface to assign a message to one or more users 30. In the example embodiment depicted in FIG. 17E, an administrator may select and display message information for an existing message, including message title 1752, header 1754, question 1755, and message text 1756. An administrator may also use the interface depicted in FIG. 17E to edit a message or associate a question 1755 with a message. The interface depicted in FIG. 17E may be used to create question/response cards described above with reference to FIGS. 15 and 16. An administrator may preview the message to be assigned in message preview pane 1758. Once a message has been created by an administrator, users are displayed in window 1761. The selected message may be assigned to another user by selecting buttons 1762 to add assigned users and by selecting submit button 1759.

FIG. 17F depicts an interface for displaying the status of assigned messages. In an embodiment, the interface shown in FIG. 17F displays the status of messages assigned to other users using the interface depicted in FIG. 17E. The status list depicted in FIG. 17F can be sorted by message title by selecting hyperlink 1764. Similarly, the status list can be sorted by the assigned user name and messages status by selecting hyperlinks 1766 and 1768, respectively.

FIG. 17G depicts a guest users tab 1770. In an embodiment, user 30 may select guest users tab 1770 within interface 1700 using an input device in order to create/add a new guest user, view active/current guest users, and view the history of past guest users. In an embodiment, guest users tab 1770 is used to allow user 30 to share access to selected subsets of his or her PHR information with other users they authorize by granting one-time viewing privileges. These guest users may be, for example, a caregiver or physician for user 30. Temporary access is given to the guest users through use of a newly generated username/password combination that remains active for a predetermined number of logins and/or a duration of time. In one embodiment, guest users added via selections in guest users tab 1770 can view the PHR or a designated portion of the PHR of user 30 for 24 hours. In another embodiment, the temporary access remains active for one guest user logon or 24 hours time limit, whichever comes first. A guest user may be added via the interface depicted in FIG. 17I. Additionally, specific guest user permissions may be selected using the interface depicted in FIG. 17I, which is described below.

FIG. 17H depicts an other accounts tab 1780. In an embodiment, user 30 may select other accounts tab 1780 within interface 1700 using an input device in order to see which, if any, other user account summary data user 30 has privileges to view. Other accounts tab 1780 also allows user 30 to see which, if any, other users have been granted privileges to view his or her summary account data. Other accounts tab 1780 further allows user 30 to view which portion (i.e., which summaries) of user 30's account data user 30 has authorized other users to view and which portion of account data user 30 can view for other users' accounts.

FIG. 17I depicts a user interface for adding a guest user and selecting specific guest user permissions. In an embodiment, guest user details are entered by user 30. The guest user's email address may be entered into guest user email address data entry field 1772 and guest user display name data entry field 1774. Once a guest user is added, the guest user's privileges (i.e., permissions) are selected using check boxes 1776. As shown in the exemplary interface of FIG. 17I, the permissions may include, but are not limited to demographic data, emergency contact information, permission to view insurance information, allergy information, immunizations, medications, vital signs, diagnosis, family history, and social history. After the guest user permissions have been selected by user 30, the guest user permissions are temporarily granted by selecting enter button 1778.

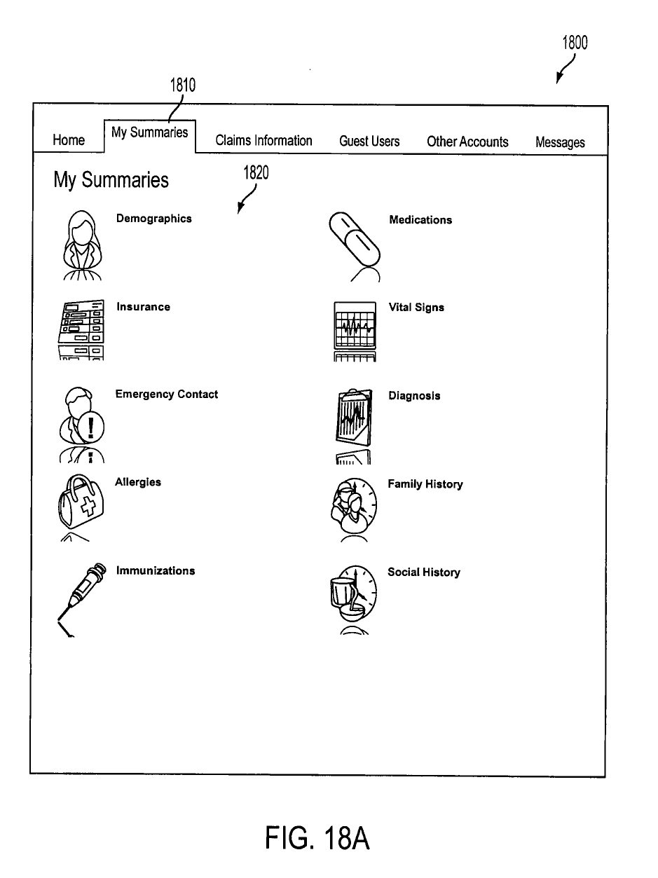

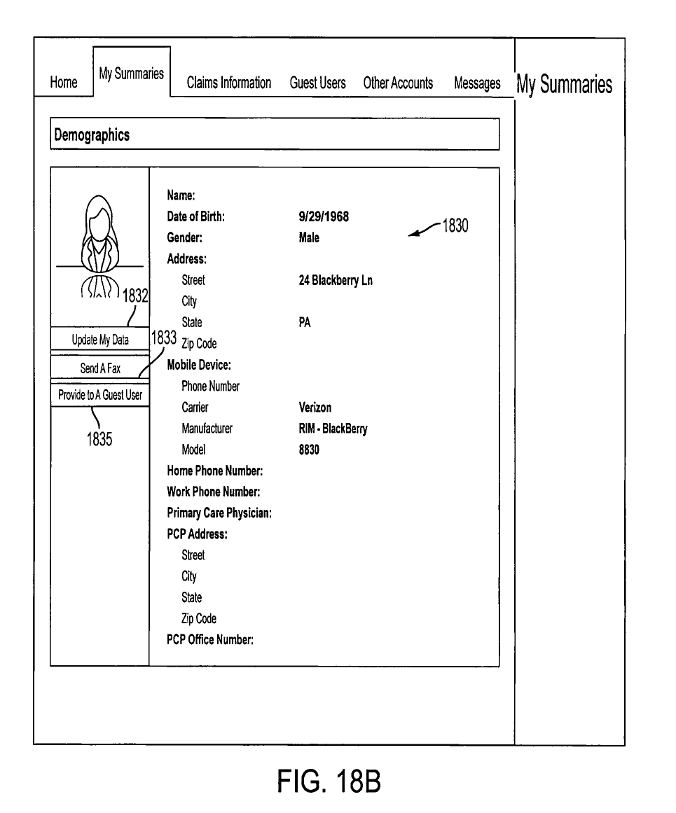

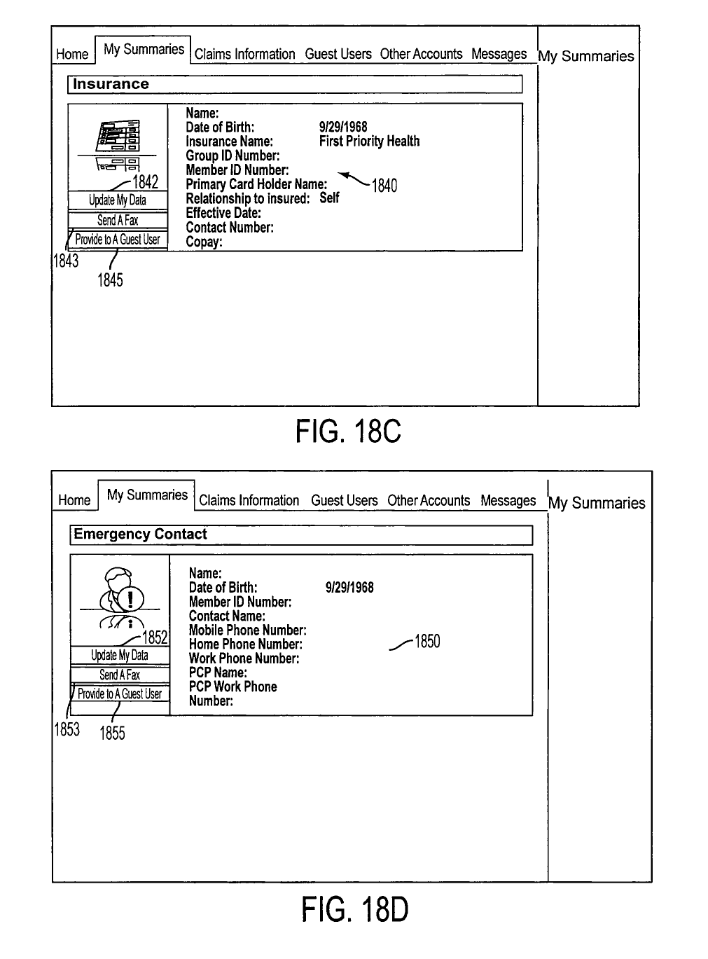

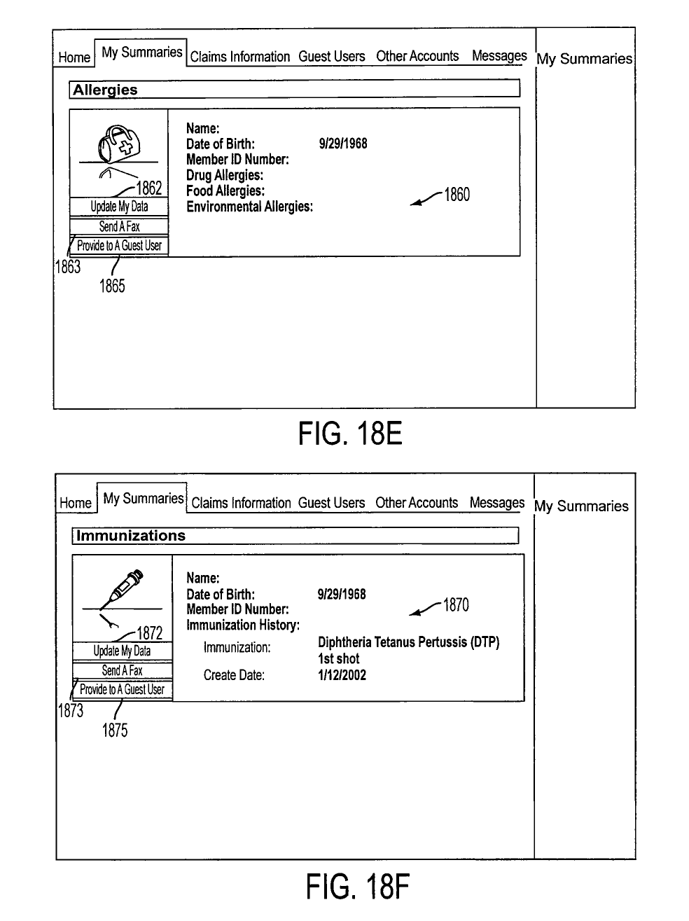

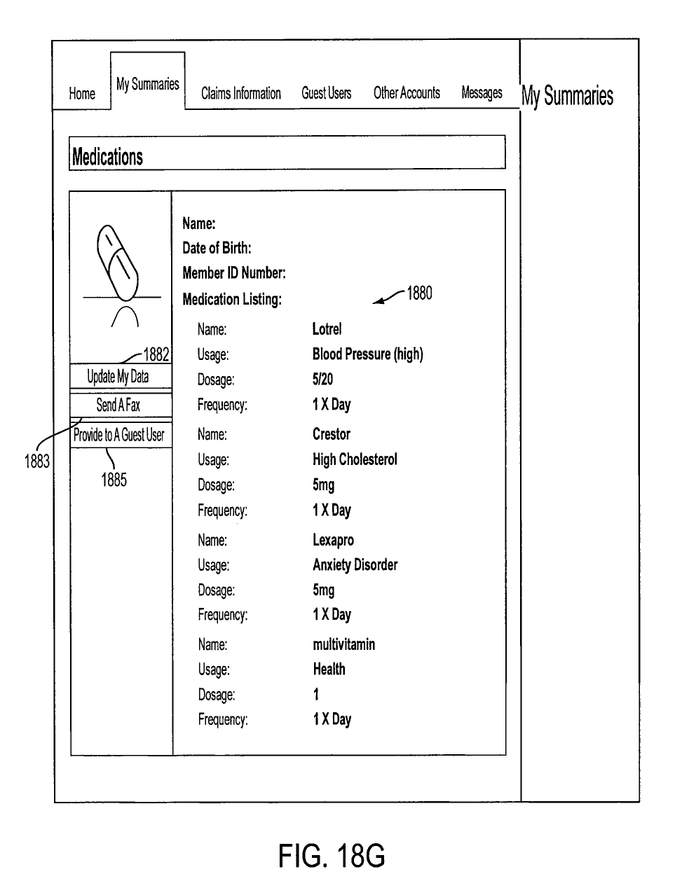

FIGS. 18A-G depict interfaces for viewing summary account data within an exemplary GUI 1800, in accordance with an embodiment of the present invention. Web pages 515 generated by web server 500 via web page generation routine 1514 may (see FIG. 10) comprise graphical user interface 1800 depicted in FIGS. 18A-G. According to an embodiment, the interfaces depicted in FIGS. 18A-G may be displayed on display 1342 of PC 600 and/or display 1343 of terminal 700 (See FIG. 2).

FIG. 18A depicts a top-level web page 515 for viewing the summary categories 1810 that a user 30 may select to view. FIG. 18A depicts a ‘my summaries’ tab 1810. In an embodiment, user 30 may select my summaries tab 1810 using an input device in order to display summaries that have been sent by system 10. In an embodiment, the summaries may include, but are not limited to the summary categories 1820 shown in FIG. 18A.

FIG. 18B depicts an exemplary GUI for displaying, faxing, and sharing demographic summary data shown in demographic pane 1830. Button 1832 can be selected, using an input device, by user 30 in order to update the user's demographic data. Button 1833 can be used to fax the summary data displayed in pane 1830. User 30, using an input device can select button 1835 in order to provide the summary data displayed in pane 1830 to a guest user. In an embodiment, the guest user access is granted using the interface depicted in FIGS. 17G and 17I.

FIG. 18C depicts an exemplary GUI for displaying, faxing, and sharing insurance summary data shown in insurance pane 1840. Button 1842 can be selected, using an input device, by user 30 in order to update the user's insurance data. Button 1843 can be used to fax the summary data displayed in pane 1840. User 30, using an input device can select button 1845 in order to provide the summary data displayed in pane 1840 to a guest user. According to an embodiment, the guest user access is granted using the interface depicted in FIGS. 17G and 17I.

FIG. 18D depicts an interface GUI for displaying, faxing, and sharing emergency contact summary data shown in emergency contact pane 1850, in accordance with an embodiment of the invention. Button 1852 can be selected, using an input device, by user 30 in order to update the user's emergency contact information. Button 1853 can be used to fax the summary data displayed in pane 1850. User 30, using an input device can select button 1855 in order to provide the summary data displayed in pane 1850 to a guest user. According to an embodiment, the guest user access is granted using the interface depicted in FIGS. 17G and 17I.

FIG. 18E depicts an interface GUI for displaying, faxing, and sharing allergy data shown in allergies pane 1860, in accordance with an embodiment of the invention. Button 1862 can be selected, using an input device, by user 30 in order to update the user's allergy information. Button 1863 can be used to fax the summary data displayed in pane 1860. User 30, using an input device can select button 1865 in order to provide the summary data displayed in pane 1860 to a guest user. According to an embodiment, the guest user access is granted using the interface depicted in FIGS. 17G and 17I.

FIG. 18F depicts an exemplary GUI for displaying, faxing, and sharing immunization summary data shown in emergency contact pane 1870. Button 1872 can be selected, using an input device, by user 30 in order to update the user's immunization information. Button 1873 can be used to fax the summary data displayed in pane 1870. User 30, using an input device can select button 1865 in order to provide the summary data displayed in pane 1870 to a guest user. In accordance with an embodiment of the present invention, guest user access is granted using the interface depicted in FIGS. 17G and 17I described above.

FIG. 18G depicts an exemplary display GUI for displaying, faxing, and sharing medication summary data shown in emergency contact pane 1880. Button 1882 can be selected, using an input device, by user 30 in order to update the user's medication information. Button 1883 can be used to fax the summary data displayed in pane 1880. User 30, using an input device can select button 1885 in order to provide the summary data displayed in pane 1880 to a guest user. In accordance with an embodiment of the present invention, guest user access is granted using the interface depicted in FIGS. 17G and 17I described above.

FIGS. 19A-J, 20A, 20B, 21A, 21B, and 22 depict how medical account information is retrieved, displayed, and updated using a graphical user interface (GUI) on mobile device 300 having display 1341, according to an embodiment of the present invention. In an embodiment, the graphical user interfaces depicted in FIGS. 19A-J, 20A, 20B, 21A, 21B, and 22 are generated by mobile device software 21. Throughout these figures, displays are shown with various hyperlinks and data entry fields, which are used to initiate action, invoke routines, or invoke other functionality. For brevity, only the differences occurring within the figures, as compared to previous or subsequent ones of the figures, is described below. According to an embodiment of the invention, the interfaces depicted in FIGS. 19A-J, 20A, 20B, 21A, 21B, and 22 may be displayed via display 1341 of mobile device 300 (See FIG. 2).

FIGS. 19A-J depict interfaces for viewing summary account data on a mobile device within an exemplary mobile device GUI 1900, in accordance with an embodiment of the present invention.

FIG. 19A depicts an authorization interface which a user 30, using input device 1905, can use to enter a PIN in PIN data entry field 1910. According to an embodiment of the invention, a user 30 of mobile device 300 is asked to choose and enter a PIN number using PIN data entry field 1910 that will be used as a security code to be able to launch and use the mobile device software 21. Exit button 1915 can be selected by user 30 to exit mobile device software 21 and OK button 1918 can be selected by user 30 to confirm the PIN entry selection made in field 1910.

FIG. 19B depicts a synchronization interface for mobile device software 21. A user, using an input device, such as input device 1905, can select to decline synchronization with hyperlink 1920. Alternatively, user 30 can proceed with synchronizing information on mobile device 300 by selecting hyperlink 1922. The synchronization process is described above with reference to FIG. 12.

FIG. 19C depicts main menu 1930 of mobile device software 21. In the exemplary GUI shown in FIG. 19C, main menu 1930 comprises buttons 1935 that can be selected by user 30, using input device 1905, for viewing summary data, messages, guest user settings, and other accounts.

FIG. 19D depicts a summary data menu 1940 of mobile device software 21. In the example embodiment provided in FIG. 19C, main menu 1940 comprises buttons 1945 that can be selected by user 30, using input device 1905, for viewing summary demographic, insurance, emergency contact, allergy, immunization and medication data. Main menu hyperlink 1948 can be selected to return to main menu 1930.

FIG. 19E depicts an allergy summary interface 1950 of mobile device software 21. As shown in FIG. 19E, a summary of any known allergies for user 30 is displayed in display 1950. User 30 can return to the previous display by selecting back button 1958 and can invoke an options interface by selecting options button 1959.

FIG. 19F depicts an immunization summary interface 1960 of mobile device software 21. As shown in FIG. 19F, a summary of any past immunizations for user 30 is displayed in interface 1960 presented in the display of mobile device 300.

FIG. 19G depicts a demographics summary interface 1970 of mobile device software 21. As shown in FIG. 19G, a summary of demographic data for user 30 is displayed in interface 1970 on the display of mobile device 300.

FIG. 19H depicts an insurance summary interface 1980 of mobile device software 21. As shown in the exemplary interface of FIG. 19H, a summary of medical insurance data for user 30 is displayed in interface 1980 on the display of mobile device 300.

FIG. 19I depicts an emergency contact summary interface 1990 of mobile device software 21. In the example interface of FIG. 19I, a summary of emergency contact information for user 30 is displayed in interface 1990 on the display of mobile device 300.

FIG. 19J depicts a medications summary interface 1995 of mobile device software 21. In the example interface of FIG. 19J, a summary of medication information for user 30 is displayed in interface 1995 on the display of mobile device 300.

FIGS. 20A and 20B depict a user interface 2000 for viewing messages on display 1341 of mobile device 300, in accordance with an embodiment of the present invention. In FIG. 20A, messages sent to user 30 by system 10 are displayed in message pane 2010. User 30 may scroll through messages displayed in pane 2010 through use of input device 1905. User 30 may return to main menu 1930 depicted in FIG. 19C by selecting main menu hyperlink 1948. User 30 may select a message to view using input device 1905 and by subsequently selecting OK button 1918. FIG. 20B depicts a message pane 2020 for viewing a message selected in message pane 2010. User 30 may advance to a subsequent page of a selected message by selecting next button 2030. A previous page of a selected message can be displayed by selecting back button 1958. In an embodiment, next button can be selected to display a subsequent message if the last page of a selected message is currently displayed in pane 2010. Similarly, if the first page of a selected message is currently being displayed, back button 1958 can be selected to display a previous message.

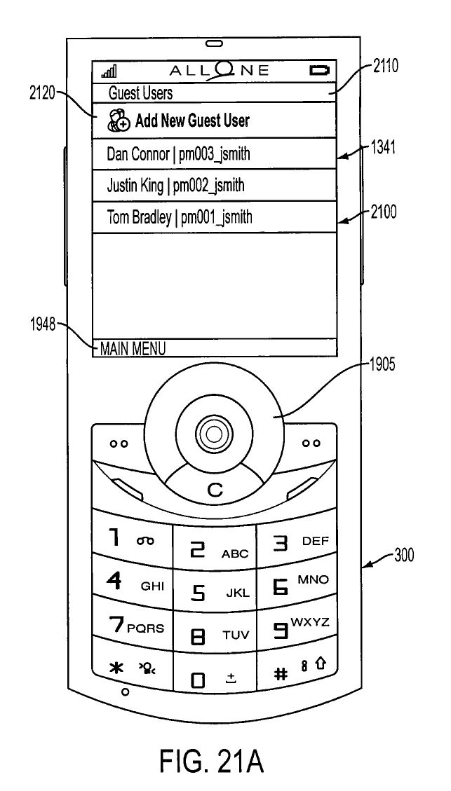

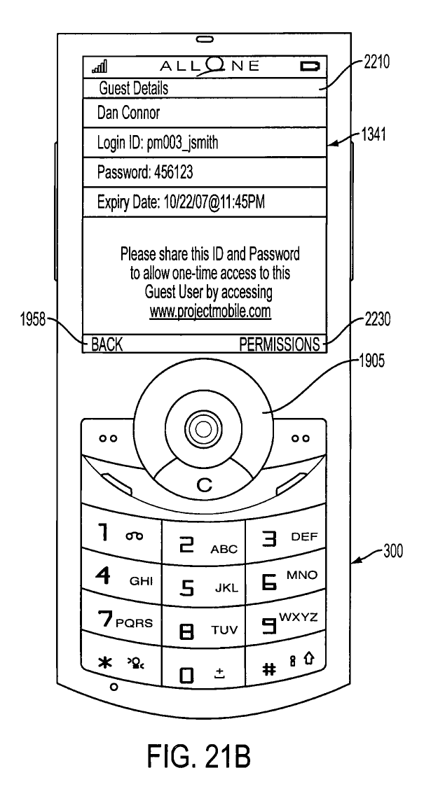

FIGS. 21A and 21B illustrate an exemplary interface 2100 for viewing guest user settings on mobile device 300, in accordance with an embodiment of the present invention. FIG. 21A depicts a guest users pane 2110 that displays current guest users that user 30 has granted temporary access to. User 30 can add a new guest user by selecting add new guest user button 2120. User 30 may return to main menu 1930 depicted in FIG. 19C by selecting main menu hyperlink 1948. FIG. 21B depicts guest user details pane 2210. As shown in FIG. 21B, the details of a guest user are displayed in guest details pane 2210. The guest user details displayed may include, but are not limited to the guest user's login ID, temporary password, and the guest user's access expiration date. User 30 may view and alter the guest user's permissions by selecting permissions button 2230. In an embodiment, the display to view and alter the guest user's permissions on mobile device 300 is similar to the interface depicted in FIG. 17I described above.

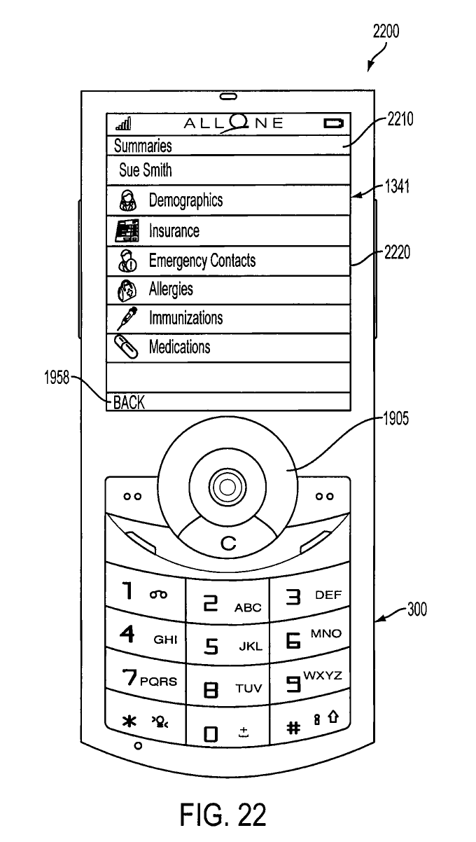

FIG. 22 illustrates a display 2200 for a guest user to view summary data on a mobile device within an exemplary GUI, in accordance with an embodiment of the present invention. As shown in FIG. 22, a guest user may view summary data for a user 30 in summary pane 2210. A guest user may select one or more of buttons 2220 to view summary data pertaining to user 30's demographic, insurance, emergency contact, allergy, immunization, and medication information. The summary interfaces displayed by selecting one or more of buttons 2220 are similar to the interfaces depicted in FIGS. 19E-19J described above. The difference between guest user interface 2200 and the interface presented to user 30 is that a guest user will typically only have temporary access to a subset of the summary account information for user 30, depending on which permissions user 30 has selected in interface 2100 depicted in FIGS. 21A and 21B.

### Example Computer System Implementation

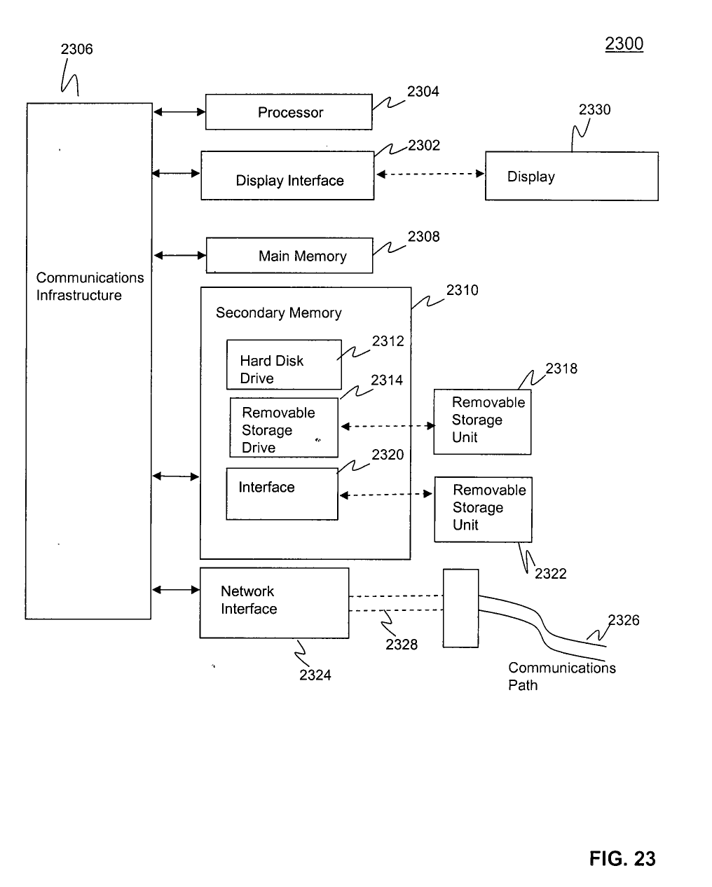

Various aspects of the present invention can be implemented by software, firmware, hardware, or a combination thereof. FIG. 23 illustrates an example computer system 2300 in which the present invention, or portions thereof, can be implemented as computer-readable code. For example, PC 600, client 650, terminal 700, server 100, web server 500, provisioning server 1230, and feed source 230 may be implemented in computer system 2300. As would be understood by a person skilled in the relevant art, PC 600, client 650, terminal 700, server 100, web server 500, provisioning server 1230, and feed source 230 may be implemented in multiple computer systems 2200. In addition, the methods illustrated by the flowchart of FIG. 13 and the message sequence charts FIGS. 14-16 can be implemented in computer system 2300. Also, the exemplary graphical user interfaces illustrated in FIGS. 17A-I and 18A-G can be implemented in computer system 2300. Various embodiments of the invention are described in terms of this example computer system 2300. After reading this description, it will become apparent to a person skilled in the relevant art how to implement the invention using other computer systems and/or computer architectures.

Computer system 2300 includes one or more processors, such as processor 2304. Processor 2304 can be a special purpose or a general-purpose processor. Processor 2304 is connected to a communication infrastructure 2306 (for example, a bus, or network).

Computer system 2300 also includes a main memory 2308, preferably random access memory (RAM), and may also include a secondary memory 2310. Secondary memory 2310 may include, for example, a hard disk drive 2312, a removable storage drive 2314, flash memory, a memory stick, and/or any similar non-volatile storage mechanism. Removable storage drive 2314 may comprise a floppy disk drive, a magnetic tape drive, an optical disk drive, a flash memory, or the like. The removable storage drive 2314 reads from and/or writes to a removable storage unit 2318 in a well-known manner. Removable storage unit 2318 may comprise a floppy disk, magnetic tape, optical disk, etc. which is read by and written to by removable storage drive 2314. As will be appreciated by persons skilled in the relevant art(s), removable storage unit 2318 includes a computer-readable storage medium having stored therein computer software and/or data.

In alternative implementations, secondary memory 2310 may include other similar means for allowing computer programs or other instructions to be loaded into computer system 2300. Such means may include, for example, a removable storage unit 2322 and an interface 2320. Examples of such means may include a program cartridge and cartridge interface (such as that found in video game devices), a removable memory chip (such as an EPROM, or PROM) and associated socket, and other removable storage units 2322 and interfaces 2320 which allow software and data to be transferred from the removable storage unit 2322 to computer system 2300.

Computer system 2300 may also include a communications interface 2324. Communications interface 2324 allows software and data to be transferred between computer system 2300 and external devices. Communications interface 2324 may include a modem, a network interface (such as an Ethernet card), a communications port, a PCMCIA slot and card, or the like. Software and data transferred via communications interface 2324 are in the form of signals which may be electronic, electromagnetic, optical, or other signals capable of being received by communications interface 2324. These signals are provided to communications interface 2324 via a communications path 2326. Communications path 2326 carries signals and may be implemented using wire or cable, fiber optics, a phone line, a cellular phone link, an RF link or other communications channels.

In this document, the terms “computer program medium” and “computer-readable medium” are used to generally refer to media such as removable storage unit 2318, removable storage unit 2322, and a hard disk installed in hard disk drive 2312. Signals carried over communications path 2326 can also embody the logic described herein. Computer program medium and computer-readable medium can also refer to memories, such as main memory 2308 and secondary memory 2310, which can be memory semiconductors (e.g. DRAMs, etc.). These computer program products are means for providing software to computer system 2300.

Computer programs (also called computer control logic) are stored in main memory 2308 and/or secondary memory 2310. Computer programs may also be received via communications interface 2324. Such computer programs, when executed, enable computer system 2300 to implement the present invention as discussed herein. In particular, the computer programs, when executed, enable processor 2304 to implement the processes of the present invention, such as the steps in the methods illustrated by flowchart 1300 of FIG. 13 message sequence charts 1400-1600 of FIGS. 14-16 discussed above. Accordingly, such computer programs represent controllers of the computer system 2300. Where the invention is implemented using software, the software may be stored in a computer program product and loaded into computer system 2300 using removable storage drive 2314, interface 2320, hard drive 2312, or communications interface 2324.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The invention also includes graphical user interfaces. The graphical user interfaces 1700, 1800, 1900, 2000, 2100, and 2200 depicted in FIGS. 17A-I, 18A-G, 19A-J, 20A-B, 21A-B, and 22, respectively, may be displayed by computer system 2300 on display 2330. Display 2330 may receive graphical user interfaces 1700, 1800, 1900, 2000, 2100, and 2200 via display interface 2302.

### CONCLUSION

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A system for providing a personal health record (PHR) to a client, comprising:
a server computer having a processor and a computer-readable medium having instructions stored thereon, the server instructions comprising:
a reception routine comprising instructions to cause the server computer to receive feed source information from a feed source, the feed source information comprising at least medical data;
a storage routine comprising instructions to cause the server computer to store the feed source information in a database;
a selection routine comprising instructions for causing the server computer to select as a PHR a subset of the feed source information stored in the database by the storage routine; and
an output routine comprising instructions for causing the server computer to send the PHR to the client.

2. The system of claim 1, the feed source comprising a processor and a computer-readable medium having feed source instructions stored thereon, the feed source instructions comprising:
an input routine comprising instructions to cause the feed source to receive feed source information from a content provider;
a storage routine comprising instructions to cause the feed source to save the feed source information in a feed source database; and
a feed source output routine comprising instructions for causing the feed source to upload the feed source information to the server computer.

3. The system of claim 2, wherein the content provider is one or more of a PHR vendor, a health care provider, a pharmacy, a hospital, a medical clinic, an assisted living facility, a government organization, or an insurance company.

4. The system of claim 3, the feed source instructions further comprising a formatting routine for reformatting the feed source information from a first format to a second format.

5. The system of claim 1, the client including a processor and a computer-readable medium having client instructions stored thereon, the client instructions comprising:
a PHR reception routine comprising instructions for causing the client to receive the PHR from the server computer;
a PHR storage routine comprising instructions to cause the client to store the PHR in the computer-readable medium of the client;
a forwarding routine for optionally transmitting at least a portion of the PHR to a desired recipient; and
a display routine comprising instructions for causing the client to display at least a portion of the PHR.

6. The system of claim 5, wherein the client is one or more of a mobile device, a personal computer, or a terminal.

7. The system of claim 5, the server instructions further comprising:
a web page generation routine to cause the server computer to generate a web page including a webform for entry of identification information, wherein the web page is displayable on the client using the display routine; and
an identification reception routine comprising instructions to cause the server computer to receive identification information entered into the webform, wherein the identification information is associated with a user associated with the client.

8. The system of claim 7, the server instructions further comprising:
a search routine comprising instructions for causing the server computer to search the database to determine whether identification information received by the identification reception routine corresponds with one or more sets of feed source information stored in the database; and
a registration routine for associating the identification information received by the identification reception routine with feed source information stored in the database.

9. The system of claim 8, the registration routine further comprising instructions to cause the server computer to identify feed source information associated by the registration routine as the PHR to be selected by the selection routine.

10. The system of claim 5, the server instructions further comprising:
a key generation routine to cause the server computer to generate an encryption key;
an encryption routine comprising instructions to cause the server computer to encrypt the PHR using the encryption key, thereby producing an encrypted PHR; and
a key transmission routine to cause the server computer to transmit the encryption key and the encrypted PHR to the client.

11. The system of claim 10, the client instructions further comprising:
a key reception routine to cause the client to receive the encryption key and the encrypted PHR from the server computer; and
a decryption routine comprising instructions to cause the client to use a received encryption key to decrypt the encrypted PHR.

12. The system of claim 1, wherein the reception routine further comprises an update routine comprising instructions to cause the server computer to prompt the feed source to send updated feed source information to the server computer.

13. The system of claim 1, the instructions further comprising a processing routine having instructions to cause the server computer to convert the received feed source information from a first format into a second format.

14. A tangible computer-readable medium having stored thereon, computer-executable instructions that, if executed by a server, cause the server to provide account information to a client by a server method comprising:
receiving feed source information from a feed source;
converting the received feed source information received from a first format into a second format, thereby producing converted feed source information;
storing the converted feed source information in a database;
selecting a subset of the stored feed source information as the account information; and
transmitting the account information to the client.

15. The tangible computer-readable medium of claim 14, further comprising a second computer-readable medium having stored thereon computer-executable instructions that, if executed by a client processor, cause the client processor to display the account information at the client by a client method comprising:
receiving the account information from the server computer;
storing the received account information in the second computer-readable medium;
optionally transmitting at least a portion of the account information to a desired recipient; and
displaying the account information at the client using a user interface on the client.

16. The tangible computer-readable medium of claim 15, further comprising a third computer-readable medium having stored thereon computer-executable instructions that, if executed by a web server processor, cause the web server processor to receive identification information by a web server method comprising:
generating a web page including a webform for entry of identification information, wherein the web page is displayable on the client using the user interface of the client;
receiving identification information entered into the webform on the client, wherein the identification information identifies a user associated with the client; and
forwarding the received identification information to the server.

17. The tangible computer-readable medium of claim 16, the server method further comprising searching the database to determine whether a specific set of forwarded identification information corresponds with feed source information stored in the database.

18. The tangible computer-readable medium of claim 15, the server method further comprising:
generating an encryption key;
before optionally transmitting, encrypting the account information using the encryption key; and
sending the encryption key to the client.

19. A method for accessing medical information at a client device having a processor and a memory, comprising:
transmitting, to a remote server, identification information, wherein the identification information identifies at least a user associated with the client device;
receiving, at the client device, an encryption key from the remote server;
receiving, at the client device, a uniform resource locator (URL) from the remote server, wherein the URL corresponds to an address where software is located;
downloading, onto the client device, software located at the URL;
installing the software on the client device;
launching the software;
entering the encryption key into the software, thereby validating the software; and
upon successful validation, receiving, at the client device, medical information from the remote server, wherein the medical information is associated with the user identified in the transmitted identification information.

20. The method of claim 19 further comprising:
selecting, at the client, a personal identification number (PIN); and
prior to the launching, entering the PIN.

21. The method of claim 19 further comprising saving the received medical information in a database in the memory of the client device.

22. The method of claim 19 further comprising updating the medical information at the client device by establishing a connection to the remote server and downloading updated medical information from the server.

23. The method of claim 19 further comprising:
before transmitting, entering identification information into a webform hosted on a web server, wherein the identification information comprises at least two of the following: a username, a password, a phone number associated with the client device, a service provider of the client device, model information for the client device, a name of an owner of the client device, and an email address associated with an owner of the client device;
wherein the transmitting further comprises transmitting, from the web server to the remote server, the identification information entered into the webform; and
wherein the receiving, at the client device, medical information from the remote server further comprises receiving medical information from the remote server, wherein the medical information is selected by the remote server based upon the identification information entered into the webform.

24. A mobile device configured to allow a first user to view account information, the mobile device having a computer-readable medium having instructions stored thereon, the instructions comprising:
an installation routine that requires the first user to enter an encryption key to enable the mobile device to decrypt encrypted account information; and a password to prevent users who do not know the password from accessing the account information;
a decryption routine that uses the encryption key to decrypt the encrypted account information, thereby producing decrypted account information;
a display routine that allows the first user to view the decrypted account information;
a synchronization routine that causes the mobile device to connect to a server to request the account information from the server;
a reception routine that causes the mobile device to receive the account information from the server; and
a storage routine that causes the mobile device to store the account information received from the server.

25. The mobile device of claim 24, the instructions further comprising an encryption routine for encrypting the account information stored by the storage routine.

26. The mobile device of claim 24, the instructions further comprising a special access password routine which sends a special access password to a second user to allow the second user to view the account information of the first user.

27. The mobile device of claim 26, wherein the special access password routine allows the first user to set a maximum number of times the second user can user the special access password.

28. The mobile device of claim 26, wherein the special access password routine allows the first user to set a duration of time after which the special access password will expire.

29. The mobile device of claim 24, the instructions further comprising a privileged access routine which allows the first user to send a privileged access request to the server, wherein the privileged access request causes the server to allow a second user to access a selected subset of the account information.
